(19) United States
(12) Patent Application Publication
(10) Pub. No.: US 2024/0292996 A1
(43) Pub. Date: Sep. 5, 2024

(54) WATER EXCHANGE BASE STATION, INTELLIGENT CLEANING MACHINE AND INTELLIGENT CLEANING MACHINE WATER EXCHANGE SYSTEM

(71) Applicant: Woan Technology (Shenzhen) Co., Ltd., Shenzhen (CN)

(72) Inventors: Zhichen LI, Shenzhen (CN); Yang PAN, Shenzhen (CN); Wei HOU, Shenzhen (CN); Jiahui WANG, Shenzhen (CN); Zhuo CHEN, Shenzhen (CN); Jiangang LI, Shenzhen (CN); Lan HU, Shenzhen (CN)

(21) Appl. No.: 18/594,839

(22) Filed: Mar. 4, 2024

(30) Foreign Application Priority Data
Mar. 4, 2023 (CN) 202310249988.4
Sep. 7, 2023 (CN) 202311161578.0
Sep. 7, 2023 (CN) 202322439730.9

(51) Int. Cl. A47L 11/40; A47L 11/24; A47L 11/28; B67D 7/02

(52) U.S. Cl. CPC A47L 11/4091; A47L 11/24; A47L 11/28; A47L 11/4005; A47L 11/4019; A47L 11/4025; A47L 11/4083; B67D 7/0294; A47L 2201/022; A47L 2201/024; A47L 2201/026

(57) ABSTRACT

A water exchange base station including a main body, a sewage exchange port, a clear water exchange port, a first sewage connecting port, a first clear water connecting port arranged on the main body, and an inlet valve; when the clear water port of the intelligent cleaning machine is docked with the clear water exchange port and in the state of supplying clear water, the clear water exchange port supplies the clear water to the intelligent cleaning machine; when the sewage port of the intelligent cleaning machine is docked with the sewage exchange port and in the state of sewage discharging, the sewage inside the intelligent cleaning machine is drawn out from the sewage exchange port and discharged from the first sewage connecting port to the outside.

### CROSS REFERENCE TO RELATED APPLICATIONS

The present application claims priorities of a Chinese patent application, with application Ser. No. 20/231,0249988.4, filed on Mar. 4, 2023; a Chinese patent application, with application Ser. No. 20/232,2439730.9, filed on Sep. 7, 2023; and a Chinese patent application, with application Ser. No. 20/231,1161578.0, filed on Sep. 7, 2023; the contents each of which are incorporated in the present application by reference.

### TECHNICAL FIELD

The present application relates to the technical field of water exchange base stations, and more particularly to a water exchange base station, an intelligent cleaning machine, and an intelligent cleaning machine water exchange system.

### BACKGROUND

Intelligent cleaning machines are becoming more and more popular due to their high degree of automation. In order to further enhance the automation capability of the intelligent cleaning machines, existing intelligent cleaning machines (such as: a cleaning robot that integrates sweeping and mopping) are usually equipped with base stations (such as: cleaning base stations, etc.).

In the working process of the intelligent cleaning machines, there are many scenarios that require water. The existing intelligent cleaning machines are small in size, and after cleaning for a period of time, it is necessary to replenish water inside the intelligent cleaning machines and discharge the sewage inside the intelligent cleaning machines; or the intelligent cleaning machine base stations are used to replenish the clear water to the intelligent cleaning machines, and the sewage in intelligent cleaning machines are discharged through the intelligent cleaning machine base stations. However, the clear water in the clear water tank in the intelligent cleaning machine base station needs to be manually replenished, the sewage in the sewage tank in the intelligent cleaning machine base station needs to be manually processed, which is inconvenient to use, and if the sewage tank is not cleaned in time, it is easy to breed bacteria and produce odor, thus affecting the user experience.

### SUMMARY

An object of the present application is to provide a water exchange base station, an intelligent cleaning machine, and an intelligent cleaning machine water exchange system, so as to solve the technical problem that the sewage in the sewage tank in the intelligent cleaning machine base station needs to be manually processed, and the use is inconvenient and the user experience is affected.

In order to achieve above object, the present application provides a water exchange base station configured for automatically docking with an intelligent cleaning machine, and the water exchange base station includes:
a main body;
a sewage exchange port, arranged on the main body and configured for docking with a sewage port of the intelligent cleaning machine;
a clear water exchange port, arranged on the main body and configured for docking with a clear water port of the intelligent cleaning machine;
a first clear water connecting port, arranged on the main body and configured for connecting with an external water source;
a first sewage connecting port, arranged on the main body and in communication with the sewage exchange port and configured for discharging a sewage to an outside; and
an inlet valve, configured for controlling a clear water to enter the water exchange base station or the intelligent cleaning machine;
when the clear water port of the intelligent cleaning machine is docked with the clear water exchange port and is in a state of supplying clear water, the first clear water connecting port is in communication with the clear water exchange port, and the clear water exchange port supplies the clear water to the intelligent cleaning machine; and
when the sewage port of the intelligent cleaning machine is docked with the sewage exchange port and is in a state of discharging sewage, the sewage in the intelligent cleaning machine is drawn out from the sewage exchange port and discharged from the first sewage connecting port to the outside.

In addition to one or more of the features described above, or as an alternative to any of the foregoing embodiments, the main body is provided with a pump, when the sewage port of the intelligent cleaning machine is docked with the sewage exchange port and is in the state of discharging sewage, the pump draws out the sewage in the intelligent cleaning machine from the sewage exchanging port; the main body is provided with a sewage processing device, a sewage inlet of the sewage processing device is in communication with the sewage exchange port, and a sewage outlet of the sewage processing device is in communication with the first sewage connecting port; the sewage processing device is connected with the pump and configured for drawing out the sewage of the intelligent cleaning machine and pumping into the sewage processing device through the pump when in the state of discharging sewage.

In addition to one or more of the features described above, or as an alternative to any of the foregoing embodiments, the sewage processing device is provided therein with an upper receiving chamber and a lower receiving chamber that are in communication with each other, the lower receiving chamber is connected with the sewage inlet to input the sewage into the lower receiving chamber; the upper receiving chamber is connected with the sewage outlet to discharge the sewage filtered in the upper receiving chamber; a filter assembly is provided between the upper receiving chamber and the lower receiving chamber, and the pump is configured for drawing out the sewage in the intelligent cleaning machine and guides the sewage successively passing through the lower receiving chamber, the filter assembly, and the upper receiving chamber.

In addition to one or more of the features described above, or as an alternative to any of the foregoing embodiments, the filter assembly includes a filter layer configured for a water flow to pass through and a support structure arranged in the filter layer; a lower portion of the support structure is provided with a plurality of first through grooves configured for the sewage entering into the support structure after being filtered, and an upper portion of the support structure is provided with a plurality of second through grooves configured for outputting the sewage into the sewage outlet from the support structure after being filtered.

In addition to one or more of the features described above, or as an alternative to any of the foregoing embodiments, the upper portion of the support structure is provided with a positioning portion located in the upper receiving chamber, and a side surface of the positioning portion is provided with the plurality of second through grooves; the lower portion of the support structure is provided with a support portion located in the lower receiving chamber, the filter layer is fixed on the support portion, and a side surface of the support portion is provided with the plurality of first through grooves.

In addition to one or more of the features described above, or as an alternative to any of the foregoing embodiments, an outer wall of the sewage processing device is provided with a cleaning connecting port in communication with the upper receiving chamber, the cleaning connecting port is in communication with first clear water connecting port through a cleaning pipe, and the cleaning connecting port is configured for inputting the clear water to clean the filter assembly.

In addition to one or more of the features described above, or as an alternative to any of the foregoing embodiments, an outer wall of the sewage processing device is provided with an opening in communication with an interior of the sewage processing device, and the filter assembly is detachably installed into the interior of the sewage processing device through the opening.

In addition to one or more of the features described above, or as an alternative to any of the foregoing embodiments, the main body is further provided therein with a sewage access control device in communication with the sewage processing device and configured for controlling the sewage to enter the sewage processing device, and/or for controlling the sewage to be discharged out of the sewage processing device after flushing the sewage processing device.

In addition to one or more of the features described above, or as an alternative to any of the foregoing embodiments, the sewage access control device includes a first connecting port, a second connecting port, a valve, and a third connecting port; the third connecting port is in communication with the sewage processing device, and the valve is configured for controlling the sewage to enter the sewage processing device from the first connecting port and the third connecting port, and/or for controlling the sewage to be discharged out of the third connecting port and the second connecting port successively after flushing the sewage processing device.

In addition to one or more of the features described above, or as an alternative to any of the foregoing embodiments, the sewage access control device includes a control casing; the valve includes a first valve and a second valve; a sewage channel is arranged in the control casing, and the first connecting port, the second connecting port, and the third connecting port are arranged on an outer wall of the control casing and are in communication with the sewage channel; the first valve is arranged at the first connecting port and configured for controlling the sewage to pass through the first connecting port, the sewage channel and the third connecting port successively to enter into the sewage processing device; the second valve is arranged at the second connecting port and configured for controlling the sewage to be discharged out of the third connecting port, the sewage channel and the second connecting port successively after flushing the sewage processing device.

In addition to one or more of the features described above, or as an alternative to any of the foregoing embodiments, the main body is further provided with an integrated casing; the sewage access control device, the inlet valve and the sewage processing device are arranged on the integrated casing, and the integrated casing is further provided with a multi-way pipe; the multi-way pipe is provided with a first water connecting port, a second water connecting port and a drainage connecting port that are in communication with each other; the first water connecting port is connected with the sewage access control device and configured for discharging the sewage after flushing the sewage processing device, the second water connecting port is connected with the sewage processing device and configured for discharging the sewage processed by the sewage processing device, and the drainage connecting port is configured for discharging water entering the multi-way pipe to the outside.

In addition to one or more of the features described above, or as an alternative to any of the foregoing embodiments, the multi-way pipe further includes a third water connecting port; the third water connecting port is in communication with the first water connecting port, the second water connecting port and the drainage connecting port; and the third water connecting port is connected with a first clear water tank of the water exchange base station and configured for discharging excess clear water in the first clear water tank.

In addition to one or more of the features described above, or as an alternative to any of the foregoing embodiments, the inlet valve is a three-way valve, the three-way valve is provided with an inlet port, a first outlet port, and a second outlet port; the inlet port is configured for inputting clear water, the first outlet port is in communication with the sewage processing device, the second outlet port is in communication with the first clear water tank of the water exchange base station; and the three-way valve is configured for controlling the clear water entering from the inlet port and the first outlet port successively to flush the sewage processing device, or for controlling the clear water entering from the inlet port and the second outlet port successively to replenish clear water to the first clear water tank.

In addition to one or more of the features described above, or as an alternative to any of the foregoing embodiments, an outer wall of the first clear water tank is provided with a clear water inlet and a clear water outlet that are in communication with an interior of the first clear water tank, the inlet valve is in communication with the clear water inlet for controlling the clear water input through the clear water inlet to replenish the clear water to the first clear water tank, the clear water outlet is in communication with the clear water exchange port for replenishing the clear water to the intelligent cleaning machine through the clear water exchange port; the clear water outlet is connected with a three-way pipe, the three-way pipe is provided with a first pipe port, a second pipe port, and a third pipe port that are in communication with each other, the first pipe port is connected to an air replenish valve, the second pipe port is in communication with the clear water outlet, and the third pipe port is in communication with the clear water exchange port to replenish the clear water to the intelligent cleaning machine through the clear water exchange port.

In addition to one or more of the features described above, or as an alternative to any of the foregoing embodiments, the first clear water tank is provided with a quick connector, a first end of the quick connector is the clear water inlet, a second end of the quick connector is provided with an inlet channel, and the clear water inlet is in communication with the inlet channel so that the clear water enters the first clear water tank; the first clear water tank is provided therein with a water volume control device, an end of the water volume control device is movably connected in the inlet channel, and when the clear water in the first clear water tank reaches a preset degree, the water volume control device blocks the inlet channel so that the clear water is prevented from entering the first clear water tank.

In addition to one or more of the features described above, or as an alternative to any of the foregoing embodiments, the main body is provided with a charging connector electrically connected with the pump, and the charging connector is configured for obtaining an electric energy from the intelligent cleaning machine.

In addition to one or more of the features described above, or as an alternative to any of the foregoing embodiments, the main body is provided therein with a battery configured for supplying power to a communication module, so that the water exchange base station is in communication with the intelligent cleaning machine before or during docking with the intelligent cleaning machine.

In addition to one or more of the features described above, or as an alternative to any of the foregoing embodiments, the water exchange base station further includes:
a water collection groove, arranged at a bottom of the main body and configured for collecting water leaking out of the main body;
a first control module, arranged in the main body; and
a water level detection member, at least partially arranged in the water collection groove and electrically connected with the first control module; when a water level in the water collection groove spreads to the water level detection member, the first control module controls the water exchange base station to stop work.

In addition to one or more of the features described above, or as an alternative to any of the foregoing embodiments, the main body includes a housing and a bottom cover; the bottom cover is arranged at a bottom of the housing, and the water collection groove is arranged above the bottom cover; a bottom wall of the housing is provided with at least one diversion port in communication with the water collection groove, and the water leaking from the main body is gathered in the water collection groove through the diversion port.

In addition to one or more of the features described above, or as an alternative to any of the foregoing embodiments, the water level detection member includes a positive probe and a negative probe that are electrically connected to the first control module; the positive probe and the negative probe are symmetrical and spaced apart, and lower ends of the positive probe and the negative probe are at least partially extended into the water collection groove.

In addition to one or more of the features described above, or as an alternative to any of the foregoing embodiments, the main body is further provided therein with a second control module and a first detection module, and the second control module is electrically connected with the first detection module;
the first detection module is configured for detecting whether the intelligent cleaning machine is docked with the water exchange base station in place; and
the second control module is configured for controlling to supply the clear water to the clear water port of the intelligent cleaning machine through the clear water exchange port of the water exchange base station, and/or to collect the sewage from the sewage port of the intelligent cleaning machine through the sewage exchange port of the water exchange base station; and for controlling to stop supply the clear water and/or collect the sewage according to a preset time or detection information from the intelligent cleaning machine.

The present application further provides an intelligent cleaning machine configured for automatically docking with the water exchange base station described above, and the intelligent cleaning machine includes:
a shell;
a second clear water tank, arranged inside the shell; and
a sewage tank, arranged inside the shell;
in which the shell is provided with a clear water port in communication with the second clear water tank and a sewage port in communication with the sewage tank; the sewage port is configured for docking with the sewage exchange port of the water exchange base station to discharge sewage to an outside through the water exchange base station, and the clear water port is configured for docking with the clear water exchange port of the water exchange base station to connect an external water source through the water exchange base station and supply clear water to the intelligent cleaning machine.

In addition to one or more of the features described above, or as an alternative to any of the foregoing embodiments, a rechargeable battery is provided in the shell, and the shell is provided with a charging portion electrically connected to the rechargeable battery, and the charging portion is configured for supply power to a pump of the water exchange base station.

In addition to one or more of the features described above, or as an alternative to any of the foregoing embodiments, the shell is further provided therein with a third control module and a second detection module electrically connected with the third control module; the sewage tank is provided therein with a sewage sensor configured for detecting whether the sewage is full, and the second clear water tank is provided therein with a clear water sensor configured for detecting whether the clear water is empty;

the third control module is configured for controlling the intelligent cleaning machine to enter a state of water exchanging and move to the water exchange base station after the sewage sensor detects that the sewage in the sewage tank is full, or after the clear water sensor detects that the clear water in the second clear water tank is empty;

the second detection module is configured for detecting a location of the water exchange base station when the intelligent cleaning machine is in the state of water exchanging, so that the sewage port is docked with the sewage exchange port of the water exchange base station and/or the clear water port is docked with the clear water exchange port of the water exchange base station; and

the third control module is further configured for controlling to start and to stop discharging and/or supplying water based on the preset time, information from the water exchange base station or the detection information from the intelligent cleaning machine after the intelligent cleaning machine is docked with the water exchange base station in place.

The present application further provides an intelligent cleaning machine water exchange system, which includes the water exchange base station described above, the intelligent cleaning machine described above, and a cleaning base station; and the water exchange base station is configured for supplying water to the intelligent cleaning machine, or for drawing out the sewage in the intelligent cleaning machine when the intelligent cleaning machine is automatically docked with the water exchange base station, and the cleaning base station is configured for supplying a power to the intelligent cleaning machine and for collecting a dust in the intelligent cleaning machine.

Compared with the prior art, one or more of the above technical solutions in the water exchange base station, the intelligent cleaning machine, and the intelligent cleaning machine water exchange system have at least one of the following technical effects:

When the clear water port of the intelligent cleaning machine is docked with the clear water exchange port of the water exchange station and in the state of supplying clear water, the first clear water connecting port is in communication with the clear water exchange port, and the clear water from an external water source (e.g., a faucet) is supplied to the interior of the intelligent cleaning machine through the first clear water connecting port. The intelligent cleaning machine and the water exchange station do not require manual replenishment, which is convenient to use and greatly improves the user experience.

When the sewage port of the intelligent cleaning machine is docked with the sewage exchange port of the water exchange base station and in the state of discharging sewage, the sewage inside the intelligent cleaning machine is drawn out from the sewage exchange port and discharged from the first sewage connecting port to the outside. The sewage inside the intelligent cleaning machine and the water exchange base station does not require manual processing or cleaning, which is convenient to use and greatly improves the user experience.

### BRIEF DESCRIPTION OF THE DRAWINGS

In order to explain the embodiments of the present application more clearly, a brief introduction regarding the accompanying drawings that need to be used for describing the embodiments of the present application or the prior art is given below; it is obvious that the accompanying drawings described as follows are only some embodiments of the present application, for those skilled in the art, other drawings can also be obtained according to the current drawings on the premise of paying no creative labor.

FIG. 1 is a structural schematic view of a water exchange base station in the present application;

FIG. 2 is another structural schematic view of a water exchange base station in the present application;

FIG. 3 is a structural schematic view of a base seat of a water exchange base station in the present application;

FIG. 4 is another structural schematic view of a base seat of a water exchange base station in the present application;

FIG. 5 is an explosive schematic view of a base seat of a water exchange base station in the present application;

FIG. 6 is a sectional view of a base seat of a water exchange base station in the present application;

FIG. 7 is an explosive schematic view of an elastic floating structure of a water exchange base station in the present application;

FIG. 8 is a structural schematic view of a base body of a water exchange base station in the present application;

FIG. 9 is another structural schematic view of a base body of a water exchange base station in the present application;

FIG. 10 is a structural schematic view of a base body with a housing being hidden in the present application;

FIG. 11 is another structural schematic view of a base body with a housing being hidden in the present application;

FIG. 12 is a first sectional view of a base body in the present application;

FIG. 13 is a second sectional view of a base body in the present application;

FIG. 14 an explosive schematic view of a sewage processing device in the present application;

FIG. 15 is a sectional view of a sewage processing device in the present application;

FIG. 16 is a structural view of an intelligent cleaning machine in the present application;

FIG. 17 is a structural view of an intelligent cleaning machine with a shell being hidden in the present application;

FIG. 18 is a structural schematic view of a water exchange base station in the present application;

FIG. 19 is top view of a water exchange base station in the present application;

FIG. 20 is a structural schematic view of an integrated mechanism used for a water exchange base station of an intelligent cleaning machine in the present application;

FIG. 21 is an explosive view of an integrated mechanism used for a water exchange base station of an intelligent cleaning machine in the present application;

FIG. 22 is a structural schematic view of a sewage access control device in the present application;

FIG. 23 is a sectional view of a sewage access control device in the present application;

FIG. 24 an explosive view of a sewage access control device in the present application;

FIG. 25 is a structural schematic view of a sewage processing device and a sewage access control device in the present application;

FIG. 26 is an explosive view of a sewage processing device in the present application;

FIG. 27 is a sectional view of a sewage processing device in the present application;

FIG. 28 is a structural schematic view of a first clear water tank in the present application;

FIG. 29 is a structural schematic view of a first clear water tank with an upper cover being hidden in the present application;

FIG. 30 is a sectional view of a first clear water tank in the present application;

FIG. 31 is a structural schematic view of a water exchange base station of an intelligent cleaning machine in the present application;

FIG. 32 is a sectional view along an A-A line in FIG. 31;

FIG. 33 is a structural schematic view of a housing in the present application;

FIG. 34 is an enlarged view at B in FIG. 33;

FIG. 35 is a structural schematic view of a bottom cover in the present application;

FIG. 36 is an explosive view of a housing and a bottom cover in the present application.

### DETAILED DESCRIPTION OF EMBODIMENTS

In order to make the purpose, the technical solution and the advantages of the present application be clearer and more understandable, the present application will be further described in detail below with reference to accompanying figures and embodiments. It should be understood that the specific embodiments described herein are merely intended to illustrate but not to limit the present application.

It is noted that when a component is referred to as being “fixed to” or “disposed on” another component, it can be directly or indirectly on another component. When a component is referred to as being “connected to” another component, it can be directly or indirectly connected to another component. The terms such as “up”, “down”, “left”, “right”, and so on are the directions or location relationships shown in the accompanying figures, which are only intended to describe the present application conveniently and simplify the description, but not to indicate or imply that an indicated device or component must have specific locations or be constructed and manipulated according to specific locations; therefore, these terms shouldn't be considered as any limitation to the present application. In addition, terms “the first” and “the second” are only used in describe purposes, and should not be considered as indicating or implying any relative importance, or impliedly indicating the number of indicated technical features. As such, technical feature(s) restricted by “the first” or “the second” can explicitly or impliedly comprise one or more such technical feature(s). In the description of the present application, “a plurality of” means two or more, unless there is additional explicit and specific limitation.

In order to make the purpose, the technical solution and the advantages of the present application be clearer and more understandable, herein, the present application is further described in detail below with reference to accompanying figures and embodiments.

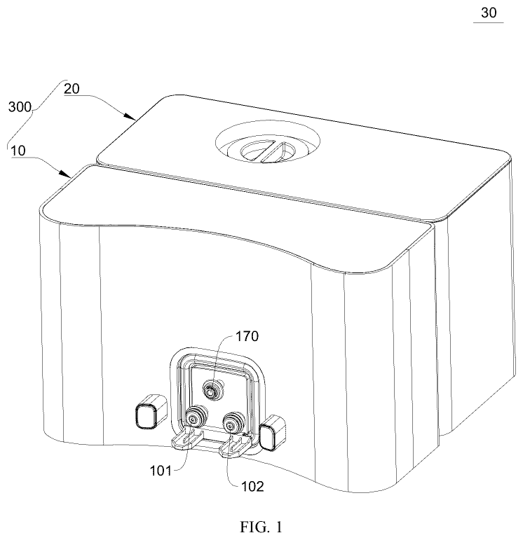

In one embodiment of the present application (i.e., Embodiment 1), as shown in FIGS. 1 to 17, a water exchange base station 30 is provided for automatically docking with an intelligent cleaning machine 40.

As shown in FIGS. 1, 9 and 16, the water exchange base station 30 includes a main body 300, and a sewage exchange port 101, a clear water exchange port 102, a first sewage connecting port 201, a first clear water connecting port 202 that are arranged on the main body 300, and an inlet valve for controlling the clear water entering the water exchange base station 30 or the intelligent cleaning machine 40. The sewage exchange port 101 is used for docking with the sewage port 45 of the intelligent cleaning machine 40, and the clear water exchange port 102 is used for docking with the clear water port 44 of the intelligent cleaning machine 40. In some embodiments, the main body 300 can be arranged in a square structure as a whole. The intelligent cleaning machine 40 can have a sweeping and mopping function, a single mopping function, or a single sweeping function.

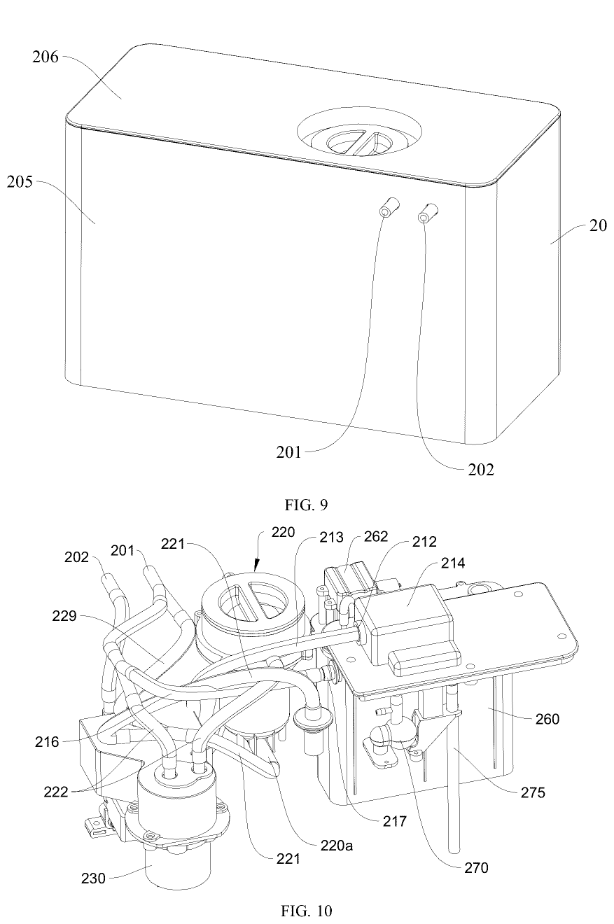

As shown in FIGS. 1 and 9, the first clear water connecting port 202 is used to connect to an external water source. Specifically, the first clear water connecting port 202 is connected to the faucet or the clear water pipe connecting port on the faucet converter through the water pipe (not shown), the clear water is transmitted to the first clear water connecting port 202 through the faucet. The first clear water connecting port 202 can be in communication with the clear water exchange port 102 through the water pipe or other devices, and which is not limited herein.

As shown in FIGS. 1 and 9, the first sewage connecting port 201 is in communication with the sewage exchange port 101, and the first sewage connecting port 201 is used to discharge sewage to the outside. Specifically, the first sewage connecting port 201 is connected to a sink, a toilet or a floor drain through a water pipe (not shown). The first sewage connecting port 201 can be in communication with the sewage exchange port 101 through the water pipe or other devices, and which is not limited herein.

It is understood that, in the present application, communication can be directly in communication with each other, indirectly in communication with each other, or controlled by a valve or a pump, etc., in addition, communication can be always in communication with each other, or can be in communication with each other in a certain state (the state of supplying water supply or discharging water), and which is not limited herein.

As shown in FIGS. 1, 9 and 16, when the clear water port 44 of the intelligent cleaning machine 40 is docked with the clear water exchange port 102 of the water exchange base station 30 and is in the state of supplying clear water, the first clear water connecting port 202 is in communication with the clear water exchange port 102, and the clear water from the faucet is supplied to the intelligent cleaning machine 40 from the clear water exchange port 102 through the first clear water connecting port 202. The intelligent cleaning machine 40 and the water exchange base station 30 do not need manual replenishment, which is convenient to use and greatly improves the user experience.

As shown in FIGS. 1, 9 and 16, when the sewage port 45 of the intelligent cleaning machine 40 is docked with the sewage exchange port 101 of the water exchange base station 30 and is in the state of discharging sewage, the sewage in the intelligent cleaning machine 40 is drawn out from the sewage exchange port 101 and discharged to the outside from the first sewage port 201. The sewage in the intelligent cleaning machine 40 and the water exchange base station 30 do not need manual processing or cleaning, which is convenient to use and greatly improves the user experience. In addition, the sewage in the water exchange base station 30 can be discharged and cleaned in time, and the water exchange base station 30 is not easy to breed bacteria and produce odor.

In another embodiment of the present application, as shown in FIGS. 1, 10, 11 and 16, the main body 300 is provided with a pump 230, which may be located inside or outside the main body 300. When the sewage port 45 of the intelligent cleaning machine 40 is docked with the sewage exchange port 101 and is in the state of discharging sewage, the pump 230 provides power to draw out the sewage in the intelligent cleaning machine 40 from the sewage exchange port 101 and discharge the sewage from the first sewage port 201 to the outside, so as to realize the automatic discharge of sewage. The pump 230 can be a self-priming pump, or a diaphragm pump and other pump structures.

In another embodiment, there is no pump arranged in the water exchange base station 30, at this time, after the intelligent cleaning machine 40 is docked with the water exchange base station 30, the sewage in the intelligent cleaning machine 40 is automatically discharged to the water exchange base station 30 by using a height different, so that the water exchange base station 30 takes out the sewage in the intelligent cleaning machine 40.

As shown in FIGS. 1, 11, 13, 14 and 16, the main body 300 is provided with a sewage processing device 220, and the outer wall of the sewage processing device 220 is provided with a sewage inlet 220a and a sewage outlet 220b that are in communication with the interior of the sewage processing device 220, and the sewage inlet 220a of the sewage processing device 220 is in communication with a sewage exchange port 101. Specifically, the sewage inlet 220a can be in communication with the sewage exchange port 101 through the water pipe or other devices, and the sewage outlet 220b of the sewage processing device 220 is in communication with the first sewage connecting port 201 through the sewage outlet pipe 222. The sewage processing device 220 is connected with the pump 230 for drawing out the sewage from the intelligent cleaning machine 40 to the sewage processing device 220 through the pump 230 during the state of discharging sewage. Specifically, when the sewage port 45 of the intelligent cleaning machine 40 is docked with the sewage exchange port 101 of the water exchange base station 30 and in the state of discharging sewage, the pump 230 operates, and the sewage in the intelligent cleaning machine 40 flows into the sewage processing device 220 through the sewage exchange port 101 and the sewage inlet 220a, then the sewage in the sewage processing device 220 is discharged through the sewage outlet 220b, the sewage outlet pipe 222 and the first sewage connecting port 201 to the pool, the toilet or the floor drain and other places to achieve automatic sewage discharging.

In addition, the sewage in the sewage processing device 220 does not need manual processing and the sewage processing device 22 is convenient to use, and the sewage in the sewage processing device 220 can be discharged and cleaned in time, and it is not easy to breed bacteria and produce odor in the sewage processing device 220, which greatly improves the user experience.

In a specific embodiment, as shown in FIG. 10, the pump 230 is connected to the sewage outlet pipe 222, and in other embodiments, the pump 230 can also be connected between the sewage inlet 220a and the sewage exchange port 101.

As shown in FIGS. 1, 10, 13, 15 and 16, the sewage processing device 220 is provided with an upper receiving chamber 223 and a lower receiving chamber 224 that are in communication with each other. The lower receiving chamber 224 is connected with the sewage inlet 220a to input sewage into the lower receiving chamber 224 from the sewage inlet 220a. The upper receiving chamber 223 is connected with the sewage outlet 220b to discharge the filtered sewage in the upper receiving chamber 223 from the sewage outlet 220b. A filter assembly 240 is arranged between the upper receiving chamber 223 and the lower receiving chamber 224. The pump 230 is used to draw out the sewage in the intelligent cleaning machine 40, so that the sewage flows from the sewage inlet 220a and passes through the lower receiving chamber 224, the filter assembly 240 and the upper receiving chamber 223 successively, then the sewage is filtered through the filter assembly 240, and the filtered sewage is discharged from the sewage outlet 220b, the sewage outlet pipe 222 and the first sewage connecting port 201 to the pool, the toilet or the floor drain, and so on. Specifically, the filter assembly 240 can filter impurities such as large dust and large sludge in the sewage, so that the filtered sewage will not cause blockage or damage to the pump 230 when it passes through the pump 230. After the sewage is filtered by the filter assembly 240 in the sewage processing device 220, the sewage is discharged through a single pump 230 (the pump 230 used to draw out the sewage from the intelligent cleaning machine, the pump 230 is a self-priming pump). It is not necessary to set up a vacuum pump for pumping the sewage from the intelligent cleaning machine 40 to the water exchange base station 30, an impeller pump for discharging the sewage from the water exchange base station 30, and a sewage tank for storing the sewage, thus saving costs and reducing the volume of the water exchange base station 30 to facilitate the installation of the water exchange base station 30. In the embodiment, the sewage flows from bottom to top for filtration, so that the subsequent filtered sewage can flow out directly under the action of gravity, and at the same time facilitate the flushing of the subsequent filter assembly 240.

In some embodiments, the filter assembly 240 can be a primary filter box, an intermediate filter box, an advanced filter box, or an arbitrary combination of two or more of the primary filter box, the intermediate filter box, and the advanced filter box, which is not limited herein. Where the filter box can be installed inside the sewage processing device 220 by clamping, bonding, or screwing, which is not limited herein.

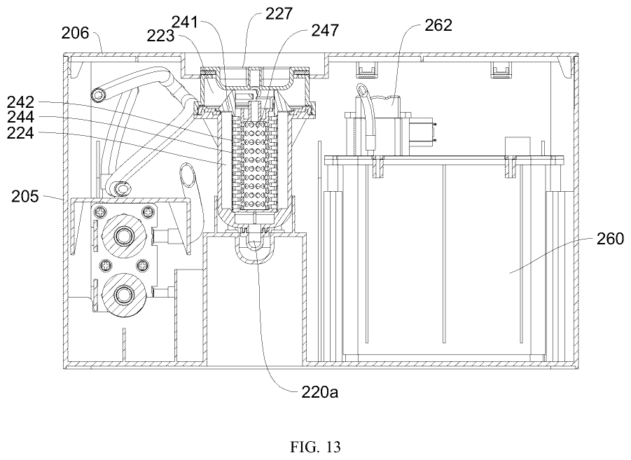

Further, as shown in FIGS. 13, 14 and 15, the filter assembly 240 includes a filter layer 244 through which water can flow through and a support structure 241 arranged within the filter layer 224. The support structure 241 can be installed in the sewage processing device 220 by clamping, bonding, or screwing, which is not limited herein. A lower portion of the support structure 241 is provided with a plurality of first through grooves 242, the filter layer 244 covers the plurality of first through grooves 242, and the first through grooves 242 are used for inputting the sewage filtered through the filter layer 244 into the support structure 241; an upper portion of the support structure 241 is provided with a plurality of second through grooves 243, and the second through grooves 243 are used for outputting the filtered sewage from the support structure 241 into the sewage outlet 220b of the sewage processing device 220, so that the sewage can only be discharged from the sewage outlet 220b after filtered by the filter layer 224, and the filtration effect is well.

In the embodiment, the filter layer 244 can be a filter cotton, a filter net or a filter cloth, etc., which is not limited herein.

Further, as shown in FIGS. 13, 14 and 15, the upper portion of the support structure 241 is provided with a positioning portion 245 located in the upper receiving chamber 223, a side surface of the positioning portion 245 is provided with the plurality of second through grooves 243, and the lower portion of the support structure 241 is provided with a support portion 246 located in the lower receiving chamber 224. The filter layer 244 is fixed on the side wall of the support portion 246, which is convenient for the filter layer 244 to be installed on the support structure 241, and the side surface (side wall) of the support portion 246 is provided with the plurality of first through grooves 242, which is convenient for the filter layer 244 to cover the first through grooves 242, and the assembly is convenient.

Preferably, as shown in FIGS. 13, 14 and 15, the support portion 246 is in the shape of a round barrel, which increases the side wall area of the support portion 246, so that the area of the filter layer 244 covering the side wall of the support portion 246 is increased, the contact area between the sewage and the filter layer 244 is increased, and the filtration efficiency and filtration effect of the filter layer 244 are improved. In the embodiment, the bottom of the support portion 246 is sealed to facilitate the sewage in the lower receiving chamber 224 to enter the support portion 246 from the filter layer 244 on the side wall of the support portion 246, thereby improving the filtration efficiency and filtration effect of the filter layer 244.

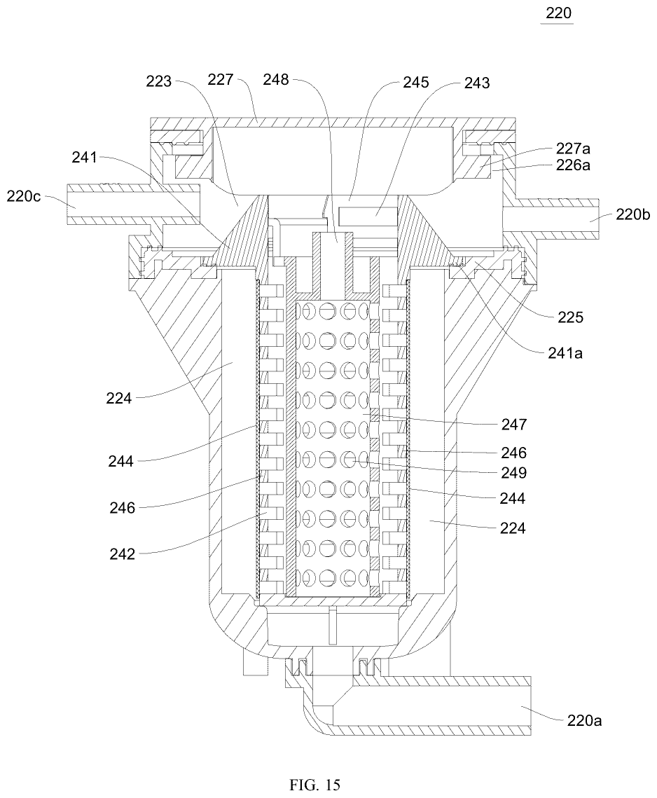

Preferably, as shown in FIG. 15, the sewage outlet 220b and the sewage inlet 220a are arranged at an upper end and a lower end of the sewage processing device 220 respectively, so that the sewage is filtered from the bottom to top through the filter assembly 240, and the filter assembly 240 is flushed from the top to bottom. In other embodiments, the sewage outlet 220b and the sewage inlet 220a can also be arranged at any position on the outer wall of the sewage processing device 220.

Further, as shown in FIG. 15, a mounting ring 225 is arranged between the upper receiving chamber 223 and the lower receiving chamber 224 in the interior of the sewage processing device 220, and the support structure 241 is arranged through a ring hole of the mounting ring 225, and a step 241a convexly arranged at a middle portion of the supporting structure 241 is in contract with the mounting ring 225. Thus, the support structure 241 is installed inside the sewage processing device 220. where the support structure 241 and the mounting ring 225 can be connected by clamping, bonding, or screwing, etc..

As shown in FIGS. 10, 11, 14 and 15, the outer wall of the sewage processing device 220 is provided with a cleaning connecting port 220c being in communication with the upper receiving chamber 223. The cleaning connecting port 220c is in communication with the first clear water connecting port 202 through a cleaning pipe 228, and the cleaning connecting port 220c is used to input the clear water to clean the filter assembly 240. The sewage inlet 220a of the sewage processing device 220 is in communication with the first sewage connecting port 201 through an impurity discharge pipe 229 for discharging the sewage for cleaning the filter assembly 240. Specifically, the clear water from the faucet flows into the upper receiving chamber 223 of the sewage processing device 220 along the first clear water connecting port 202, the cleaning pipe 228 and the cleaning connecting port 220c and is sprayed onto the filter assembly 240, thereby flushing the impurities such as large dust and sludge attached to the filter assembly 240 (including the support structure 241 and the filter layer 244). The large dust, large sludge and other impurities flushed off the filter assembly 240 fall into the lower receiving chamber 224, and then discharged through the sewage inlet 220a, the impurity discharge pipe 229 and the first sewage connecting port 201, so as to clean the large dust, large sludge and other impurities attached to the filter assembly 240, so that the filter assembly 240 can be used for a long time without or reduce manual cleaning. In addition, the clear water flowing from the cleaning connecting port 220c can flush the filter assembly 240 from top to bottom, and the impurities such as large dust and sludge attached to the filter assembly 240 are flushed more fully, and the flushing effect is good. In the embodiment, the sewage inlet 220a is in communication with the first sewage connecting port 201, and in the process of cleaning the filter assembly 240, the sewage inlet 220a is used as the sewage discharge port to discharge the sewage in the sewage processing device 220 after cleaning. In other embodiments, other outlets can be used as the sewage discharge port to discharge the sewage in the sewage processing device 220 after cleaning.

In another embodiment of the present application, as shown in FIGS. 11, 14 and 15, the filter assembly 240 also includes an inner core structure 247. The inner core structure 247 is located in the support structure 241, the inner core structure 247 is tubular, an upper end of the inner core structure 247 is provided with an inner core connecting port 248 in communication with the interior of the inner core structure 247; the inner core connecting port 248 is in communication with the cleaning connecting port 220c to access water, the tube wall of the inner core structure 247 is provided with a plurality of first through holes 249, the first through holes 249 are used to clean the filter layer 244 by discharging the clear water from inside the inner core structure 247 to the filter layer 244. Specifically, the inner core structure 247 is mainly used to clean the filter layer 244, and the water sprayed from the first through holes 249 of the tube wall of the inner core structure 224 (similar to the spray water effect) can be flushed to the entire filter layer 244, so that the filter layer 244 is cleaned from top to bottom, and the flushing effect is good.

Further, as shown in FIGS. 13, 14 and 15, the outer wall of the sewage processing device 220 is provided with an opening 226 which is in communication with the interior of the sewage processing device 220. The opening 226 is larger than the filter assembly 240, and the filter assembly 240 is detachably installed inside the sewage processing device 220 through the opening 226, and the opening 226 is detachably covered with a tank cover 227. After the filter assembly 240 is used for a period of time, the user takes off the tank cover 227, and the filter assembly 240 can be removed from the interior of the sewage processing device 220 through the opening 226, which is convenient for the user to clean and replace the filter assembly 240 at any time.

Specifically, the filter assembly 240 can be stalled inside the sewage processing device 220 by clamping, or screwing, etc., so that the filter assembly 240 can be detachably installed inside the sewage processing device 220.

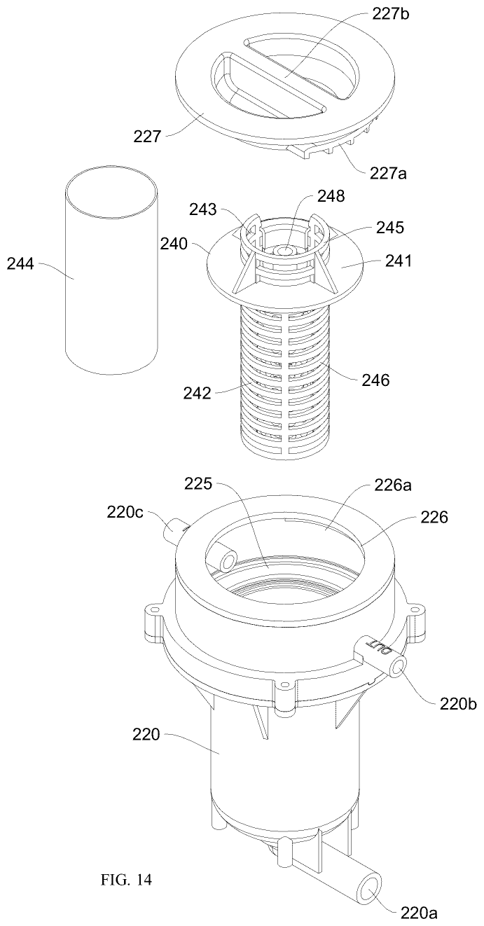

Specifically, as shown in FIGS. 14 and 15, the tank cover 227 can be connected to the opening 226 by clamping, or screwing, etc., so that the tank cover 227 can be detachably covered on the opening 226. In the specific embodiment, the inner wall of the opening 226 is provided with a plurality of slots 226a, and the outer wall of the tank cover 227 is provided with a plurality of protrusions 227a, and the user can rotate the tank cover 227 forward to engage the plurality of protrusions 227a into the plurality of slots 226a one by one, so as to fit the tank cover 227 to the opening 226. When user reverse rotates the tank cover 227, the protrusions 227a and the slots 226a are free from engagement, so that the tank cover 227 can be removed from the opening 226, the structure is simple, the operation is convenient, and which has high practicability.

Further, as shown in FIG. 14, a rotating portion 227b is provided at the top of the tank cover 227, which is convenient for the user to twist the tank cover 227 for easy operation.

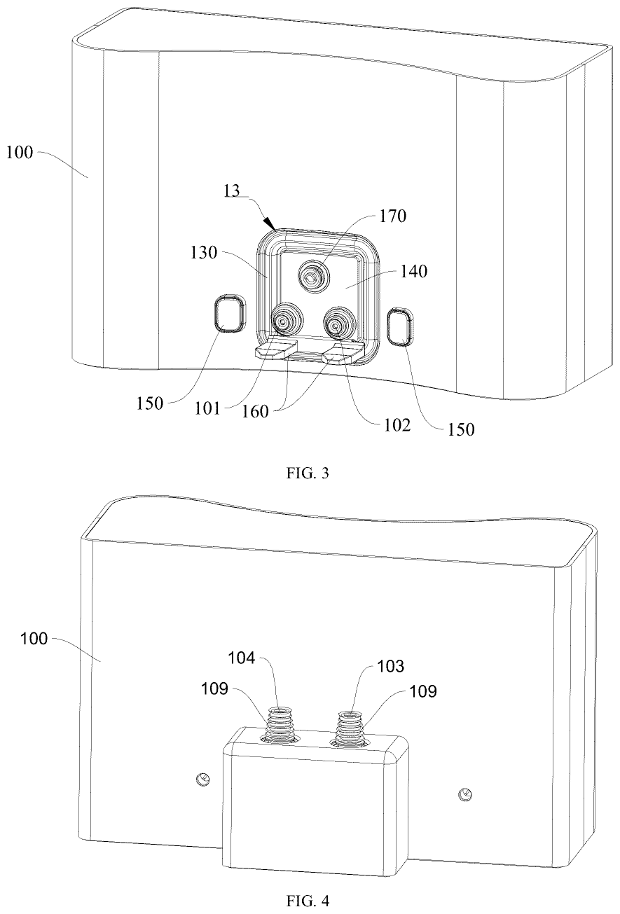

In another embodiment of the present application, as shown in FIGS. 3, 10 and 16, the main body 300 is provided with a charging connector 150 electrically connected to the pump 230, and the charging connector 150 is used to obtain electric energy from the intelligent cleaning machine 40. Specifically, a charging portion 47 of the intelligent cleaning machine 40 is docked with the charging connector 150 to form an electrical conductivity, thus providing power to the pump 230 through the intelligent cleaning machine 40 to enable the pump 230 to operate. In addition, the main body 300 is also provided with a battery for powering communication modules such as a Bluetooth module and an infrared module, so that the water exchange base station 30 can communicate with the intelligent cleaning machine 40 before or during the docking with the intelligent cleaning machine 40. In the embodiment, the water exchange base station 30 only needs to supply power to the communication module through the battery, while the pump 230 with higher operating power is supplied by the intelligent cleaning machine 40. Therefore, the water exchange base station 30 does not need to be connected to the external power supply at all times (a standby charging connecting port can be provided for charging in case of failure or complete loss of power, etc.) or use a larger rechargeable battery. The water exchange base station 30 is small in size and convenient for installation and use.

In other embodiments, the charging connector 150 can be connected to the external power supply through a power cord (not shown), and when the charging portion 47 of the intelligent cleaning machine 40 is docked with the charging connector 150, the intelligent cleaning machine 40 is charged through the external power supply to supply power to the intelligent cleaning machine, and the structure is simple.

The charging connector 150 includes a positive connector and a negative connector. The positive connector and the negative connector are connected to the positive charging portion and the negative charging portion of the intelligent cleaning machine 40 respectively to achieve conductivity.

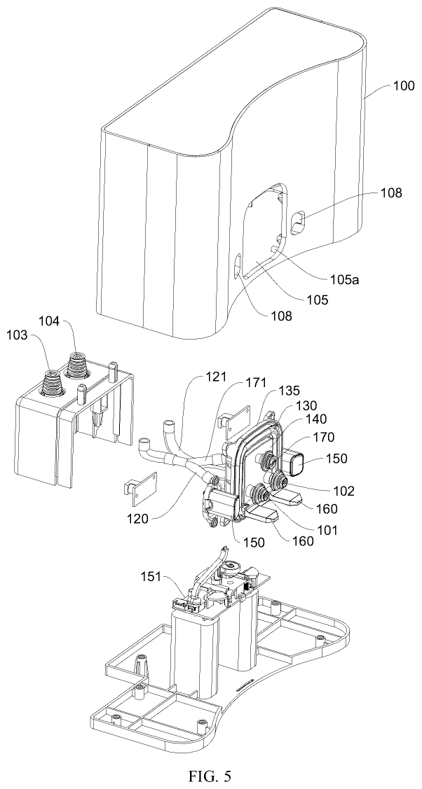

Further, as shown in FIGS. 3 and 5, the outer wall of the main body 300 is provided with a second mounting port 108, and the charging connector 150 is threaded through the second mounting port 108. The charging connector 150 can be fixed to the inner wall of the main body 300 by clamping, bonding or screwing, etc. . . . The charging connector 150 is provided with an elastic member, which is similar to the structure of the elastic charging stylus. When the charging connector 150 is docked with the charging portion 47 of the intelligent cleaning machine 40, the charging connector 150 is slightly adjusted for expansion, so as to better connect and charge the intelligent cleaning machine 40. In the embodiment, the elastic member is a spring.

Further, as shown in FIGS. 3 and 15, the charging connector 150 is used for in-place detection (that is, the charging connector 150 itself can perform in-place detection) or a in-place detection module is provided. The in-place detection module of the charging connector 150 is electrically connected with the controller inside the water exchange base station 30 for the docking in-place detection of the intelligent cleaning machine 40 and the water exchange base station 30. When the charging connector 150 is docked with the charging portion 47 of the intelligent cleaning machine 40 to form a conductive connection, it means that the intelligent cleaning machine 40 and the water exchange base station 30 are docked in place, and the next operation can be carried out (such as: supplying water to the intelligent cleaning machine 40, or drawing out the sewage in the intelligent cleaning machine 40, etc.).

In another embodiment of the present application, as shown in FIGS. 1, 10, 12, and 16, the main body 300 is also provided with a first clear water tank 210, and the first clear water tank 210 is provided with a clear water outlet 211 and a clear water inlet 212 that are in communication with the interior of the first clear water tank 210, the clear water inlet 212 of the first clear water tank 210 is in communication with the first clear water connecting port 202 through the inlet pipe 213, and the clear water outlet 211 of the first clear water tank 210 is in communication with the clear water exchange port 102. Specifically, the clear water of the faucet flows into the interior of the first clear water tank 210 through the first clear water connecting port 202, the inlet pipe 213 and the clear water inlet 212, so as to replenish the clear water to the interior of the first clear water tank 210, the first clear water tank 210 does not need to manually replenish water, which is convenient to use and the user experience is improved. When the clear water port 44 of the intelligent cleaning machine 40 is docked with the clear water exchange port 102 and in the state of supplying clear water, the clear water inside the first clear water tank 210 is replenished with clear water from the clear water outlet 211 and the clear water exchange port 102 to the interior of the intelligent cleaning machine 40 to achieve replenishing water.

Further, as shown in FIGS. 1, 11, 12 and 16, a cleaning fluid pump 262, a mixer 270 and a cleaning fluid tank 260 are also provided in the main body 300. The cleaning liquid tank 260 is in communication with the first clear water tank 210 or the mixer 270 through a cleaning liquid pipe 261. The cleaning liquid tank 260 is provided with a cleaning liquid pump 262. The mixer 270 is provided therein with a mixing chamber 271, and the mixer 270 is provided with a mixing outlet 272, a cleaning liquid inlet 273 and a clear water inlet port 274 that are in communication with the mixing chamber 271. The mixing outlet 272 is in communication with the clear water exchange port 102, the cleaning liquid inlet 273 is in communication with the cleaning liquid pipe 261, and the clear water inlet port 274 is connected with a clear water pipe 275, and the lower end of the clear water pipe 275 extends into the bottom of the first clear water tank 210. Specifically, the clear water in the first clear water tank 210 is input into the mixing chamber 271 along the clear water pipe 275, and the cleaning liquid pump 262 provides power to input the cleaning liquid in the cleaning liquid tank 260 into the mixing chamber 271 along the cleaning liquid pipe 261, and the cleaning liquid and the clear water are mixed in the mixing chamber 271, and then input into the intelligent cleaning machine 40 from the clear water exchange port 102, which improves the cleaning effect of the intelligent cleaning machine 40. In which, the cleaning fluid pump 262 can control the output of the cleaning fluid.

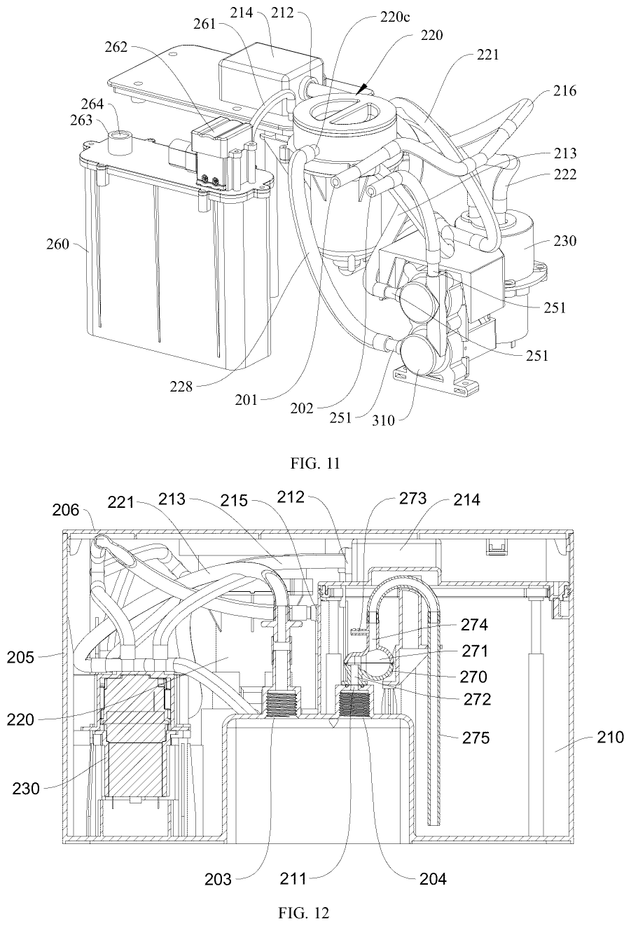

As shown in FIGS. 11 and 12, the mixer 270 can be located inside or outside the first clear water tank 210. When the mixer 270 is located inside the first clear water tank 210, the cleaning liquid pipe 261 is firstly in communication with the first clear water tank 210, and then in communication with the cleaning liquid inlet 273 of the mixer 270 through the pipeline, and the mixing outlet 272 of the mixer 270 is connected with the clear water outlet 211. When the mixer 270 is located outside the first clear water tank 210, the cleaning liquid pipe 261 is directly in communication with the cleaning liquid inlet 273 of the mixer 270. Preferably, the mixer 270 is located inside the first clear water tank 210 for easy connecting to the pipelines.

Further, as shown in FIG. 12, the mixing chamber 271 is in the shape of a gourd, the mixing outlet 272 is connected to a smaller end of the mixing chamber 271, the cleaning liquid inlet 273 and the clear water inlet port 274 are connected to a larger end of the mixing chamber 271, and the clear water in the first clear water tank 210 is input into the mixing chamber 271 along the cleaning pipe 275. The cleaning liquid in the cleaning liquid tank 260 is input into the mixing chamber 271 along the cleaning liquid pipe 261, and the cleaning liquid and clear water flow from the larger end of the mixing chamber 271 to the smaller end of the mixing chamber 271 to form a large impact and mix, so that the mixing effect of the cleaning liquid and the clear water is better.

Further, as shown in FIG. 11, the cleaning liquid tank 260 is provided with a feeding port 263 in communication with the interior of the cleaning liquid tank 260, and the feeding port 263 is detachably covered with a feeding cover 264, the cleaning liquid can be fed to the cleaning liquid tank 260 through the feeding port 263, which is convenient to operate.

The feeding cover 264 can be a plug, and the feeding cover 264 is inserted into the feeding port 263 through an interference fit, so as to cover on the feeding port 263. The feeding cover 264 can also be a buckle cover, and the feeding cover 264 is clamped to the feeding port 263 by clamping. The feeding cover 264 can also be a thread cover, the thread cover is provided with an internal thread, the feeding port 263 is provided with an external thread, the internal thread and the external thread are engaged with each other, so that the feeding cover 264 is covered on the feeding port 263. The above structural means can make the feeding cover 264 detachably connected to the feeding port 263, which is not limited herein.

As shown in FIGS, 10 and 11, the inlet valve can include a three-way valve 310. The cleaning pipe 228, the inlet pipe 213 and the first clear water connecting port 202 are respectively connected to three valve connecting ports 251 in the three-way valve 310, which is mature prior art. When the three-way valve 310 turns on the cleaning pipe 228 and turns off the inlet pipe 213, the clear water from the faucet flows into the sewage processing device 220 along the cleaning pipe 228 for flushing the filter assembly 240. When the three-way valve 310 turns on the inlet pipe 213 and turns off the cleaning pipe 228, the clear water from the faucet flows into the first clear water tank 210 from the clear water inlet 212 along the inlet pipe 213, for replenishing water to the first clear water tank 210.

In another embodiment of the present application, as shown in FIGS. 10 and 11, the inlet valve can include a first solenoid valve (not shown) and a second solenoid valve (not shown). The first solenoid valve and the second solenoid valve are respectively arranged in the cleaning pipe 228 and the inlet pipe 213, when the first solenoid valve is turned on, the clear water from the faucet flows into the sewage processing device 220 from the cleaning connecting port 220c along the cleaning pipe 228 for flushing the filter assembly 240. When the second solenoid valve is opened, the clear water from the faucet flows into the first clear water tank 210 along the inlet pipe 213 from the clear water inlet 212 to the first clear water tank 210, for replenishing water to the first clear water tank 210.

As shown in FIGS. 10 and 12, the inlet valve can also include a full water detection device 214 arranged at the top of the first clear water tank 210. The full water detection device 214 turns off the clear water inlet 212 when the clear water inside the first clear water tank 210 is full, and the clear water will not continue to refill from the clear water inlet 212 to the interior of the first clear water tank 210.

As shown in FIGS. 10 and 12, the full water detection device 214 can include a floating structure. When the water level inside the first clear water tank 210 is too high (full of water), the water level moves upward against the floating of the floating structure, so that the floating blocks the clear water inlet 212, thus turning off the clear water inlet 212. The clear water will not continue to replenish from the clear water inlet 212 to the interior of the first water tank 210, and the structure is simple.

In other embodiments, as shown in FIGS. 10 and 12, the full water detection device 214 can include a solenoid valve (not shown) located at the clear water inlet 212 and a liquid level sensor located at the top of the first clear water tank 210. When the internal water level of the first clear water tank 210 is too high to contact the liquid level sensor (when is clear water is full), the liquid level sensor transmits the signal to the solenoid valve, so that the solenoid valve turns off the clear water inlet 212, and the clear water will not continue to replenish from the clear water inlet 212 to the first clear water tank 210, and the structure is simple. The solenoid valve and the liquid level sensor are mature prior art.

Further, as shown in FIGS. 10 and 12, the first clear water tank 210 is provided with an overflow outlet 215 in communication with the interior of the first clear water tank 210, the overflow outlet 215 is in communication with the first sewage connecting port 201 through a drain pipe 216, the drain pipe 216 is provided with a third valve 217. When there is too much clear water in the first clear water tank 210, the third valve 217 is opened, and the clear water in the first clear water tank 210 can be discharged from the first sewage connecting port 201 along the drain pipe 216 to prevent the clear water in the first clear water tank 210 from overflowing outside the first clear water tank 210. The third valve 217 can be a check valve, a solenoid valve and other valve structures, that can control the drain pipe 216 to be turned on and off, which is not limited herein.

In other embodiments, the inlet valve can include a third solenoid valve (not shown). The third solenoid valve is arranged in the clear water exchange port 102 of the water exchange base station 30, and the third solenoid valve is used to control the opening and closing of the clear water exchange port 102, so as to control the clear water entering the interior of the intelligent cleaning machine 40.

The inlet valve can be a single three-way valve, a solenoid valve, or a full water detection device 214, or a combination of a three-way valve, a solenoid valve, and a full water detection device 214.

In another embodiment of the present application, as shown in FIGS. 1, 10 and 16, a gray water inlet 170 is provided on the main body 300, the gray water inlet 170 is used to access the gray water in the intelligent cleaning machine 40, and the first sewage connecting port 201 is also in communication with the gray water inlet 170 for discharging the gray water input from the intelligent cleaning machine 40 to the outside. The intelligent cleaning machine 40 can collect the gray water from other household intelligent devices (such as dehumidifiers, fish tanks, etc.) at any time, and then when the gray water port 46 of the intelligent cleaning machine 40 is docked with the gray water inlet 170 and is in the state of discharging gray water, the gray water flows into the sewage processing device 220 from the gray water inlet 170 and the sewage water inlet 220a, which does not need for manual cleaning of gray water in household intelligent devices (such as dehumidifiers), the practicality is high. The gray water is a kind of water between the clear water and the sewage, which is distinguished according to the degree of dirt. If the gray water in the household intelligent device is dirty and can not be used twice, the gray water in the household intelligent device can also be called the sewage.

The gray water inlet 170 is located on the side of the clear water exchange port 102 and the sewage exchange port 101, which is convenient for docking with the intelligent cleaning machine 40. The clear water exchange port 102 and the sewage exchange port 101 can be arranged next to each other, and the gray water inlet 170 is arranged above the clear water exchange port 102; or the gray water inlet 170 is arranged next to the clear water exchange port 102, and the sewage exchange port 101 is arranged above the clear water exchange port 102.

In another embodiment, the gray water inlet 170 and the clear water exchange port 102 can share a common connecting port.

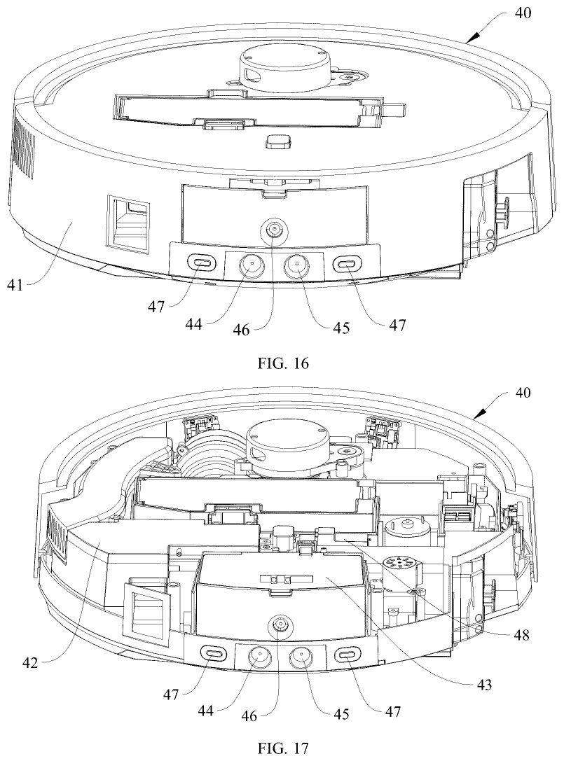

In another embodiment of the present application, as shown in FIGS. 1 and 16, the main body 300 can include a base seat 10 and a base body 20. The base seat 10 is provided with a communication device for communicating with the intelligent cleaning machine 40, the surface of the base seat 10 is provided with a docking structure for docking with the intelligent cleaning machine 40, the docking structure includes the charging connector 150, the inlet valve is arranged in the base body 20. In some embodiments, the inlet valve can also be arranged outside the base body 20, the first clear water tank 210, the sewage processing device 220 and the pump 230 can be arranged in the base body 20, and the base body 20 and the base seat 10 are formed an integrated structure or are separated structures.

The communication device can be a wireless communication module, which is a mature prior art and is widely used in a vehicle monitoring, a remote control, a telemetry, a small wireless network, a wireless meter reading, an access control system, a cell paging, an industrial data acquisition system, a wireless label, an identity identification, a non-contact RF smart card, a small wireless data terminal, a safety and fire protection system, wireless remote control system, a biological signal acquisition, a hydrometeorological monitoring, a robot control and other fields, which will not be detailed herein.

In some embodiments, the base body 20 and the base seat 10 are formed in an integrated structure, that is, the base body 20 and the base seat 10 are a whole, and the water exchange base station 30 is placed on the ground as a whole.

In other embodiments, as shown in FIG. 1, the base body 20 and the base seat 10 are assembled in an integrated structure, that is, the base body 20 and the base seat 10 can be connected as one by screwing, bonding or engaging, and the water exchange base station 30 is placed on the ground as a whole.

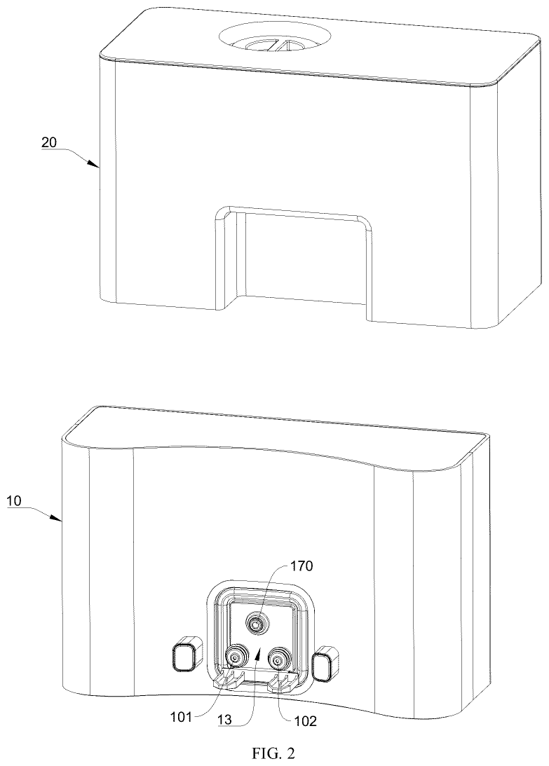

In another embodiment, as shown in FIG. 2, the base body 20 and the base seat 10 are separated structures, and the base body 20 and the base seat 10 are connected through water pipes for water flow, which can change the placement position of the base body 20 and the base seat 10.

For example, the base body 20 can be placed on the sink surface (the sink surface of the wash basin or the sink surface next to the kitchen faucet), and the base seat 10 can be placed on the ground. Because the base seat 10 is small in size and occupies a small ground area, it is convenient to be placed. The base body 20 is placed on the sink surface (the sink surface of the wash basin or the sink surface next to the kitchen faucet) to facilitate the first clear water connecting port 202 to connect to the faucet or the clear water pipe connecting port on the faucet converter through the water pipes (not shown), and to facilitate the first sewage connecting port 201 to connect to the sink, the toilet or the floor drain, etc. through the water pipes (not shown), etc., the practicality is high.

Further, as shown in FIGS. 3 and 5, the docking structure includes a fourth sewage connecting port and a fourth clear water connecting port arranged on one side of the base seat 10. The fourth sewage connecting port is the sewage exchange port 101, and the fourth clear water connecting port is the clear water exchange port 102. The other side of base seat 10 is provided with a second sewage connecting port 103 and a second clear water connecting port 104, and a sewage inlet pipe 120 and a clear water outlet pipe 121 are provided in base seat 10. Specifically, the sewage exchange port 101 is connected to the second sewage port 103 through the sewage inlet pipe 120, and the clear water exchange port 102 is connected to the second clear water connecting port 104 through the clear water outlet pipe 121.

In other embodiments, as shown in FIGS. 3 and 5, the docking structure also includes a gray water connecting port arranged on one side of the base seat 10. The gray water connecting port is the gray water inlet 170, and the gray water inlet 170 is connected to the second sewage connecting port 103 through a gray water inlet pipe 171. When the gray water inlet 170 is docked with the gray water port 46 of the intelligent cleaning machine 40 and in the state of discharging gray water, the gray water in the intelligent cleaning machine 40 flows into the sewage processing device 220 through the gray water inlet 170, the gray water inlet pipe 171, the second sewage connecting port 103, the third sewage connecting port 203, and the sewage inlet pipe 221.

Further, as shown in FIGS. 4, 8 and 10, a third sewage connecting port 203 and a third clear water connecting port 204 are arranged on one side of the base body 20 for docking with the base seat 10, and the first sewage connecting port 201 and the first clear water connecting port 202 are arranged on the other side of the base body 20. Specifically, the third sewage connecting port 203 is connected to the sewage inlet 220a of the sewage processing device 220 through the sewage inlet pipe 221, and the third clear water connecting port 204 is directly connected to the clear water outlet 211 of the first clear water tank 210, or is connected to the clear water outlet 211 of the first clear water tank 210 through the water pipe.

As shown in FIGS. 1, 4 and 8, when the base body 20 and base seat 10 are assembled in an integrated structure, the second sewage connecting port 103 of the base seat 10 is directly connected with the third sewage connecting port 203 of base body 20, and correspondingly, the second clear water connecting port 104 of the base seat 10 is directly connected with the third clear water connecting port 204 of the base body 20. As shown in FIGS. 2, 4 and 8, when base body 20 and base seat 10 are separated structures, the second sewage connecting port 103 of the base seat 10 is connected to the third sewage connecting port 203 of the base body 20 through the water pipe. Correspondingly, the second clear water connecting port 104 of the base seat 10 is connected to the third clear water connecting port 204 of the base body 20 through the water pipe.

Further, as shown in FIGS. 1, 4 and 8, the second sewage connecting port 103 and the second clear water connecting port 104 are respectively sleeved with a second elastic seal 109. The two second elastic seals 109 respectively seal the connection gap between the second sewage connecting port 103 and the third sewage connecting port 203 and the connection gap between the second clear water connecting port 104 and the third clear water connecting port 204 to play a sealing role to prevent the leakage of the clear water or the sewage.

Specifically, as shown in FIGS. 1, 5, 12 and 16, when the clear water port 44 of the intelligent cleaning machine 40 is docked with the clear water exchange port 102 of the base seat 10, the clear water inside the first clear water tank 210 flows into the intelligent cleaning machine 40 through the clear water outlet 211, the third clear water connecting port 204, the second clear water connecting port 104, the clear water outlet pipe 121, and the clear water exchange port 102, so as to replenish water to the intelligent cleaning machine 40. As shown in FIGS. 1, 5, 10, 11 and 16, when the sewage port 45 of the intelligent cleaning machine 40 is docked with the sewage exchange port 101 of the base seat 10 and is in the state of discharging sewage, the pump 230 operates, so that the sewage in the intelligent cleaning machine 40 flows into the sewage processing device 220 along the sewage exchange port 101, the sewage inlet pipe 120, the second sewage connecting port 103, the third sewage connecting port 203, the sewage inlet pipe 221 and sewage inlet 220a. Then the sewage in the sewage processing device 220 is discharged along the sewage outlet pipe 222 and the first sewage connecting port 201 to the pool, the toilet or the floor drain and other places to achieve automatic sewage discharging.

In another embodiment of the present application, as shown in FIGS. 12 and 13, the base body 20 includes a first housing body 205 and a first cover body 206. The first housing body 205 is provided with an upper end opening, and the first cover body 206 covers to the upper end opening, and a chamber is formed between the first housing body 205 and the first cover body 206, and the cleaning liquid tank 260, the first clear water tank 210, the sewage processing device 220 and the pump 230 are installed in the chamber. The base body 20 is arranged as a combination structure of the first housing body 205 and the first cover body 206 to facilitate the assembly of the cleaning liquid tank 260, the first clear water tank 210, the sewage processing device 220 and the pump 230 in the chamber.

The first cover body 206 can be covered on the upper end opening by clamping, bonding, screwing, etc., and the structure is simple.

In another embodiment of the present application, as shown in FIGS. 3 and 16, at least one of the sewage exchange port 101, the clear water exchange port 102 and gray water inlet 170 is installed on the main body 300 by means of an elastic floating structure 13, so that the docking between the clear water exchange port 102 and the clear water port 44 of the intelligent cleaning machine 40 is in place, the docking between the sewage exchange port 101 and the sewage port 45 of the intelligent cleaning machine 40 is in place, or the docking between the gray water inlet 170 and the gray water port 46 of the intelligent cleaning machine 40 is in place.

As shown in FIGS. 3 and 5, the base seat 10 is provided with a base housing 100, and the base housing 100 is provided with a first mounting port 105. The elastic floating structure 13 includes an elastic plate 130 and a support frame 140 threaded at a first mounting port 105. The elastic plate 130 is elastic, and the support frame 140 is arranged on the elastic plate 130, preferably, the support frame 140 is arranged in the middle of the elastic plate 130. The sewage exchange port 101 and the clear water exchange port 102 are arranged on the support frame 140, so that the sewage exchange port 101 and the clear water exchange port 102 can float flexibly relative to the base housing 100, so that the sewage exchange port 101 and the clear water exchange port 102 can float flexibly relative to the base housing 100.

Specifically, as shown in FIGS. 3, 6 and 16, when the sewage port 45 and the clear water port 44 of the intelligent cleaning machine 40 are docked with the sewage exchange port 101 and the clear water exchange port 102 respectively, there will be impact force applied to the sewage exchange port 101 and the clear water exchange port 102, and the elastic plate 130 is deformed by elasticity, so that the clear water exchange port 102 and the sewage exchange port 101 can be flexibly floated by the elastic plate 130 to slightly adjust their positions, so that the clear water exchange port 102 and the sewage exchange port 101 can not only accurately dock with the clear water port 44 and the sewage port 45 of the intelligent cleaning machine 40, but also buffer the impact force of the intelligent cleaning machine 40.

Further, the elastic plate 130 is made of an elastic plastic or other elastic material, and the elastic plate 130 can also be connected with an elastic member (such as a spring) to enable the elastic plate 130 to move flexibly.

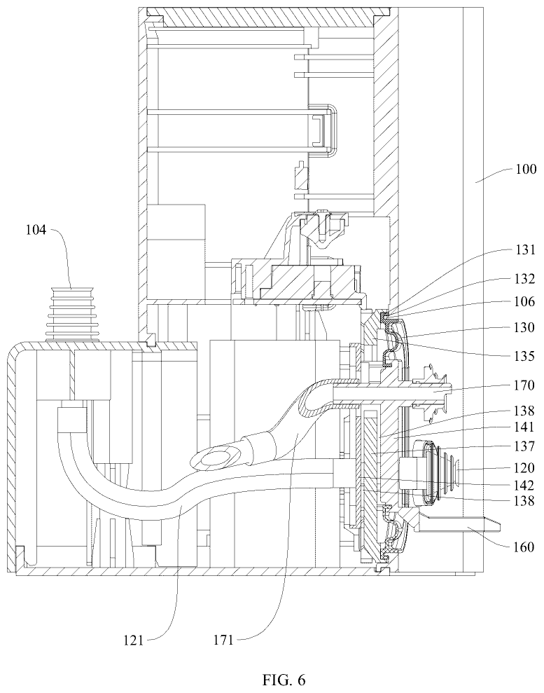

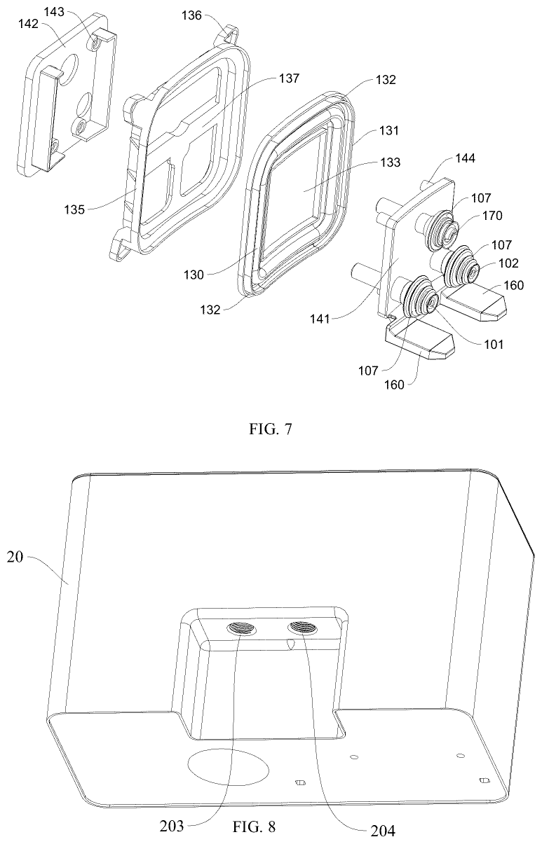

Further, as shown in FIGS. 6 and 7, the perimeter of the elastic plate 130 is extended outward with a mounting ring 131, the mounting ring 131 is abutted against the inner wall of the base housing 100, and a fixing member 135 is pressed against the mounting ring 131 and is fixedly connected with the base housing 100, so that the elastic plate 130 is fixedly installed on the first mounting port 105 and is installation is firm. The fixing member 135 can be fixedly connected with the inner wall of the base housing 100 by clamping, bonding, or screwing, etc.

In specific embodiments, as shown in FIGS. 5 and 7, the fixing member 135 is provided with a plurality of first connection holes 136 penetrating through the fixing member 135, the inner wall of the base housing 100 is provided with a plurality of first thread posts 105a, and the screw of each first screw (not shown) is threaded through a first connection hole 136 to a thread hole of a first thread post 105a, Thus, the fixing member 135 is fixedly connected to the inner wall of the base housing 100, and the structure is simple.

Further, as shown in FIGS. 6 and 7, the mounting ring 131 is provided with an annular groove 132, and the inner wall of the base housing 100 is provided with an annular protrusion 106 around the first mounting port 105, and the annular protrusion 106 is engaged into the annular groove 132, so that the elastic plate 130 is firmly connected with the inner wall of the base housing 100 and the structure is stable.

Preferably, as shown in FIGS. 6 and 7, the cross-section of the elastic plate 130 is wavy, which makes the elastic plate 130 have good elasticity.

As shown in FIGS. 6 and 7, the support frame 140 includes a first support plate 141 and a second support plate 142. The first support plate 141 and the second support plate 142 are fixedly connected to the opposite sides of the elastic plate 130, respectively, and the sewage exchange port 101 and the clear water exchange port 102 are arranged on the first support plate 141. In particular, the first support plate 141 and the second support plate 142 can be fixedly connected to the opposite sides of the elastic plate 130 by clamping, bonding, or screwing, etc. As shown in FIGS. 13 and 14, the sewage exchange port 101 and the clear water exchange port 102 and the first support plate 141 can be an integrated structure, the structure is stable, or the sewage exchange port 101 and the clear water exchange port 102 and the first support plate 141 can be separated structures, which is not limited herein.

Further, as shown in FIGS. 6 and 7, the middle of the elastic plate 130 is provided with mounting hole 133 penetrating the elastic plate 130, and the first support plate 141 and the second support plate 142 are pressed against both perimeter sides of the mounting hole 133, and the first support plate 141 and the second support plate 142 are fixedly connected by clamping, bonding, or screwing, etc. Thus, the first support plate 141 and the second support plate 142 are firmly connected to the opposite sides of the elastic plate 130.

In specific embodiments, as shown in FIGS. 6 and 7, the second support plate 142 is provided with a plurality of second connection holes 143 penetrating through the second support plate 142, the first support plate 141 is provided with a plurality of second thread posts 144, and a screw of each second screw is threaded through a second connection hole 143 to a thread hole of a second thread post 144, Thus, the first support plate 141 and the second support plate 142 are fixedly connected, and the structure is simple.

As shown in FIGS. 3, 6, 7 and 16, the fixed member 135 is provided with a limiting structure 137, and there is a gap 138 between the limiting structure 137 and the support frame 140, in which the first support plate 141 and the second support plate 142 of the support frame 140 are located on opposite sides of the limiting structure 137, respectively. The gap 138 is provided between the first support plate 141 and the second support plate 142 with the limiting structure 137, the limiting structure 137 is used to limit the travel of the elastic floating of the support frame 140 relative to the base housing 100. Specifically, when the sewage port 45 and clear water port 44 of the intelligent cleaning machine 40 move to dock with the sewage exchange port 101 and the clear water exchange port 102 respectively, the first support plate 141 will be pushed to move to the inner side of the base housing 100, and the elastic plate 130 will be elastically deformed to the inner side of the base housing 100. The first support plate 141 will not move until it is abutted against the limiting structure 137, so as to avoid the excessive movement of the first support plate 141, so as to avoid the excessive movement of the clear water exchange port 102 and the sewage exchange port 101, so as to ensure the accurate docking of the clear water exchange port 102 and the sewage exchange port 101 with the clear water port 44 and the sewage port 45 on the intelligent cleaning machine 40. When the intelligent cleaning machine 40 moves away and disconnect with the sewage exchange port 101 and the clear water exchange port 102, the intelligent cleaning machine 40 will drive the first support plate 141 towards the outside of the base housing 100, the elastic plate 130 is elastically deformed toward the outside of the base housing 100, and the second support plate 142 will not move until it is abutted against the limiting structure 137, so as to avoid the excessive movement of the second support plate 142, so as to ensure that the elastic plate 130 deforms in an appropriate range.

Further, as shown in FIGS. 3 and 16, the ends of the sewage exchange port 101 and the clear water exchange port 102 extending out of the base housing 100 are sleeved with a first elastic seal 107 respectively, so that the sewage exchange port 101 is sealingly docked with the sewage port 45 of the intelligent cleaning machine 40, and the clear water exchange port 102 is sealingly docked with the clear water port 44 of the intelligent cleaning machine 40, which play a sealing role to prevent the leaking of the clear water or the sewage.

In other embodiments, as shown in FIGS. 3, 7, and 16, the end of the gray water inlet 170 extending out of the base housing 100 is also provided with the first elastic seal 107, so that the gray water inlet 170 is sealingly docked with the gray water port 46 of the intelligent cleaning machine 40 to prevent the leaking of the gray water.

In another embodiment of the present application, as shown in FIGS. 3 and 16, the docking structure also includes a docking connector 160. The docking connector 160 is arranged on an outer wall of a side of the base housing 100. The docking connector 160 is used to position the dock with the intelligent cleaning machine 40. Specifically, the intelligent cleaning machine 40 is provided with a matching slot, and the docking connector 160 is inserted into the matching slot of the intelligent cleaning machine 40, so as to position and dock with the intelligent cleaning machine 40, so that the clear water exchange port 102 and the sewage exchange port 101 are precisely docked with the clear water port 44 and the sewage port 45 of the intelligent cleaning machine 40, or the charging portion 47 of the intelligent cleaning machine 40 is precisely docked with the charging connector 150, so as to avoid misalignment, and the structure is reliable.

Preferably, as shown in FIGS. 3 and 16, the docking connector 160 is arranged on the first support plate 141 and is located on the side of the sewage exchange port 101 and the clear water exchange port 102 for positioning and docking with the intelligent cleaning machine 40.

As shown in FIG. 5, the base housing 100 is also provided with a control circuit board 151 (i.e. a controller), and the pump 230, the cleaning fluid pump 262, the inlet valve, the charging connector 150 and the communication device are electrically connected to the control circuit board 151. In the embodiment, the control circuit board 151 can be set up by PLC or integrated chip according to the actual production needs. Since the control circuit board 151 belongs to the technology forming and mature technology in the prior art, the working principle of the control circuit board 151 how to control the water exchange base station base 10 should be familiar and able to master by those skilled in the art, which is not repeated herein.

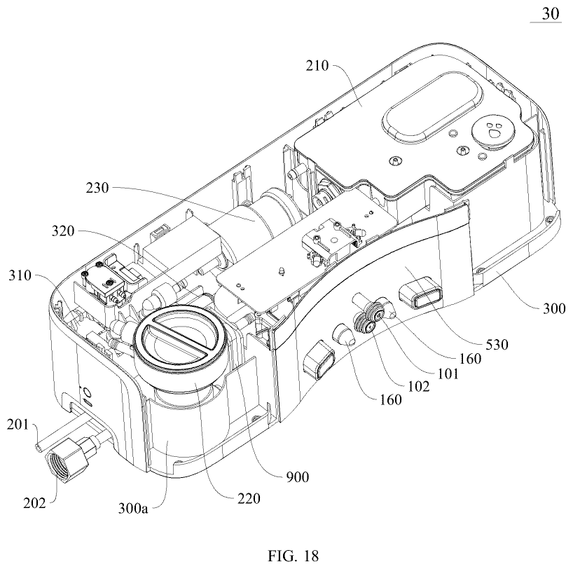

In another embodiment of the present application (i.e., Embodiment 2), as shown in FIGS. 18 to 20, the water exchange base station 30 preferably includes an integrated mechanism including an integrated casing 300a, and a sewage processing device 220, a sewage access control device 900, and an inlet valve (e.g., a three-way valve 310) located on the integrated casing 300a.

As shown in FIGS. 18 to 20, the inlet valve can be in communication with the sewage processing device 220 for controlling the clear water input to flush the sewage processing device 220, and/or the inlet valve can be in communication with the first clear water tank 210 of the water exchange base station 30 for controlling the clear water input to replenish the clear water supply to the first clear water tank 210 of the water exchange base station 30.

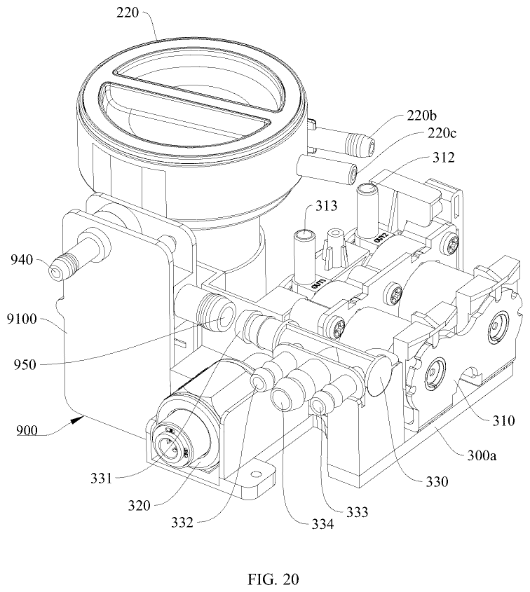

As shown in FIGS. 20 to 27, the sewage access control device 900 is in communication with the sewage processing device 220 for controlling the sewage input into the sewage processing device 220 and/or controlling the sewage discharge out of the sewage processing device 220 after flushing the sewage processing device 220.

Compared to the prior art, one or more of the above technical solutions of the integrated mechanism for the water exchange base station 30 provided by the embodiment of the present application have at least one of the following technical effects:

As shown in FIGS. 18 to 21, the sewage processing device 220, the sewage access control device 900 and the inlet valve are integrally installed on the integrated casing 300a to form an integrated mechanism, so that the overall structure of the integrated mechanism is compact and easy to be installed. The integrated mechanism is applied to the water exchange base station 30, the space occupation of the water exchange base station 30 is small, so that the volume of the water exchange base station 30 can be reduced, and the use of the water exchange base station 30 is convenient.

In another embodiment of the present application, as shown in FIGS. 22, 23, and 25, the sewage access control device 900 includes a first connecting port 940, a second connecting port 950, a valve, and a third connecting port 960. The third connecting port 960 is in communication with the sewage processing device 220. The valve is used to control the inlet of sewage from the first connecting port 940 and the third connecting port 960 into the sewage processing device 220, and/or to control the sewage to be discharged out from the third connecting port 960 and the second connecting port 950 successively after flushing the sewage processing device 220. The third connecting port 960 can be two independent connecting ports or a single connecting port according to the actual use, the sewage access control device 900 can be a single structural device, or can be a combination of multiple structural devices for controlling the sewage input into the sewage processing device 220, and/or for controlling the sewage to be discharged out of the sewage processing device 220 after flushing the sewage processing device 220.

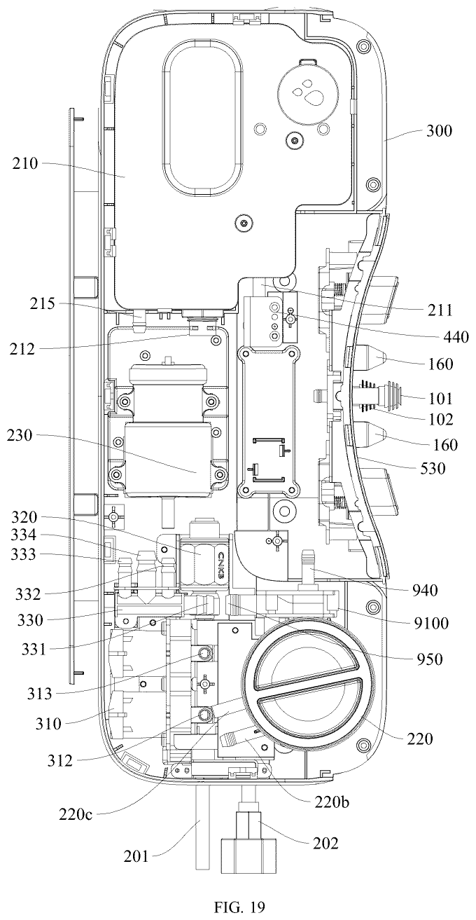

As shown in FIG. 19, the first connecting port 940 is used to be in communication with external sewage (such as the sewage inside the intelligent cleaning machine) to input the sewage. It can be understood that the first connecting port 940 can be connected to the sewage connecting port (such as: including the sewage exchange port 101) of the water exchange base station 30 through the water pipe, the sewage inside the intelligent cleaning machine 40 can be input from the first connecting port 940 by the sewage connecting port docked with the intelligent cleaning machine 40.

As shown in FIGS. 22, 23 and 25, the sewage access control device 900 also includes a control casing 9100. The valve includes a first valve 910 and a second valve 920. A sewage channel 930 is provided in the control casing 9100. The first connecting port 940, the second connecting port 950 and the third connecting port 960 are arranged on the outer wall of the control casing 9100 and are in communication with the sewage channel 930. The first valve 910 is arranged in the first connecting port 940 to control the sewage to input from the first connecting port 940, the sewage channel 930 and the third connecting port 960 into the sewage processing device 220. The second valve 920 is arranged at the second connecting port 950 to control the sewage discharged from the third connecting port 960, the sewage channel 930 and the second connecting port 950 after the flushing sewage processing device 220. It can be understood that the second connecting port 950 can be connected to the sewage connecting port of the water exchange base station 30 through the water pipe, and then the sewage connecting port discharge the sewage to the pool, the toilet or the floor drain, etc., so as to discharge the sewage, and the structure is simple.

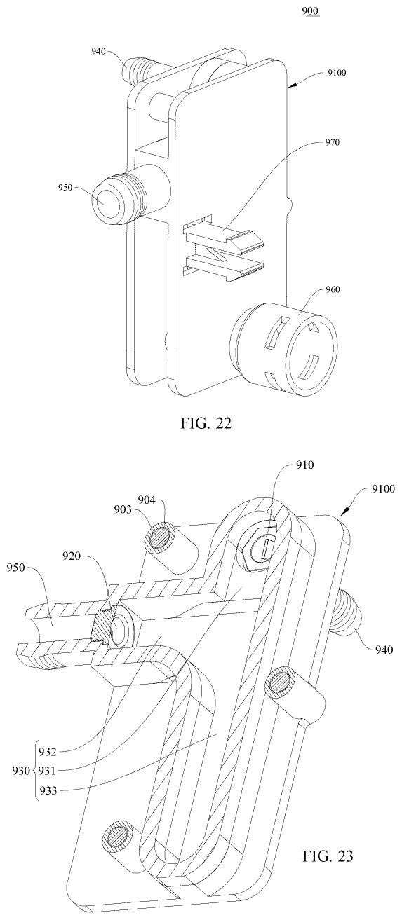

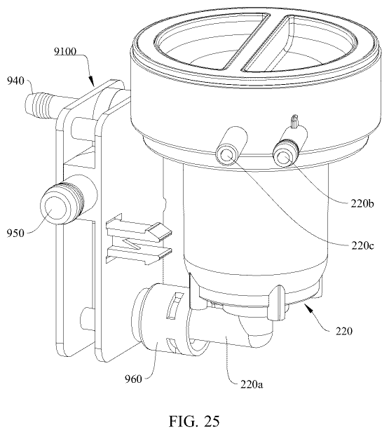

In the specific embodiment, as shown in FIGS. 23 and 25, the first valve 910 is the first check valve and the second valve 920 is the second check valve. When the sewage enters the sewage channel 930 from the first connecting port 940 and enters the sewage processing device 220 through the third connecting port 960, the sewage can enter the sewage channel 930 through the first check valve from the first connecting port 940, but the sewage in the sewage channel 930 cannot be discharged from the second connecting port 950 through the second check valve. As shown in FIGS. 23 and 25, when the clear water enters to flush the sewage processing device 220, the sewage after cleaning the sewage processing device 220 enters the sewage channel 930 through the third connecting port 960, and the sewage in the sewage channel 930 is discharged from the second connecting port 950 through the second check valve, but cannot be discharged from the first connecting port 940 through the first check valve. The structure is simple by using the first check valve and the second check valve, which does not need for electrically controlling. The first check valve or the second check valve controls the water flow to enter or out from a specific direction.

As shown in FIGS. 23 and 25, the sewage channel 930 includes a first channel segment 931 and the second channel segment 932. The two ends of the first channel segment 931 are connected with the first connecting port 940 and the third connecting port 960 respectively, which is used for the sewage from the first connecting port 940 into the first channel segment 931 through the first valve 910 and from the third connecting port 960 into the sewage processing device 220, the structure is simple. The two ends of the second channel segment 932 are connected with the third connecting port 960 and the second connecting port 950 respectively, which is used for the sewage after flushing the sewage processing device 220 being input into the second channel segment 932 from the third connecting port 960 and discharged from the second connecting port 950 through the second valve 920, the structure is simple.

In the specific embodiment, as shown in FIG. 23, the first channel segment 931 is in communication with the second channel segment 932, and the first channel segment 931 and the second channel segment 932 include a common channel 933, and the first channel segment 931 and the second channel segment 932 adopt a common channel structure, so that the overall volume of the sewage access control device 900 can be reduced, and the structure is compact and convenient for processing.

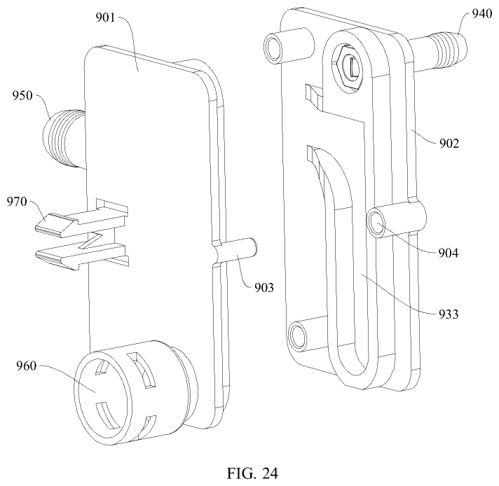

As shown in FIGS. 22 and 24, the control casing 9100 includes a first casing 901 and a second casing 902. The first casing 901 fits the second casing 902 to form the sewage channel 930 between them. The control casing 9100 is configured as a combination structure of the first casing 901 and the second casing 902 to facilitate the processing of the sewage channel 930 and the installation of the first valve 910 and the second valve 920. The first casing 901 and the second casing 902 can be fixed by clamping, bonding or screwing, etc.

Further, as shown in FIG. 24, a plurality of positioning posts 903 and positioning holes 904 matched with each other are provided between the first casing 901 and the second casing 902, and the first casing 901 and the second casing 902 are accurately assembled through the positioning posts 903 and the positioning holes 904 matching with each other, so as to facilitate assembly.

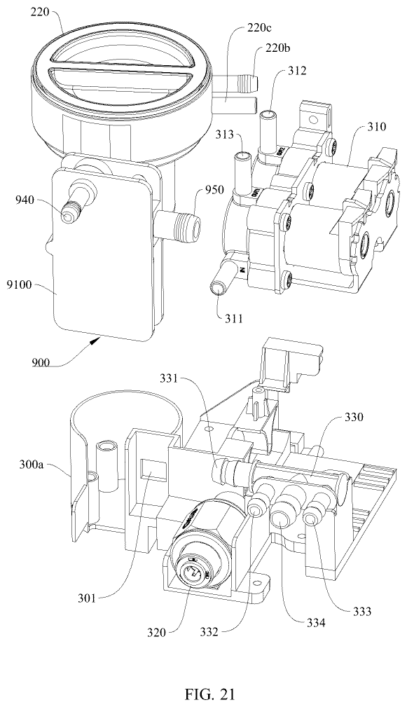

As shown in FIGS. 21 and 22, the outer wall of the control casing 9100 is provided with at least one engagement member 970, the integrated casing 300a is provided with at least one engagement groove 301, and the engagement member 970 is detachably engaged to the engagement groove 301, so that the sewage access control device 900 can be detachably installed on the integrated casing 300a for easy installation. In other embodiments, the control casing 9100 can also be installed on the integrated casing 300a by other means such as screwing.

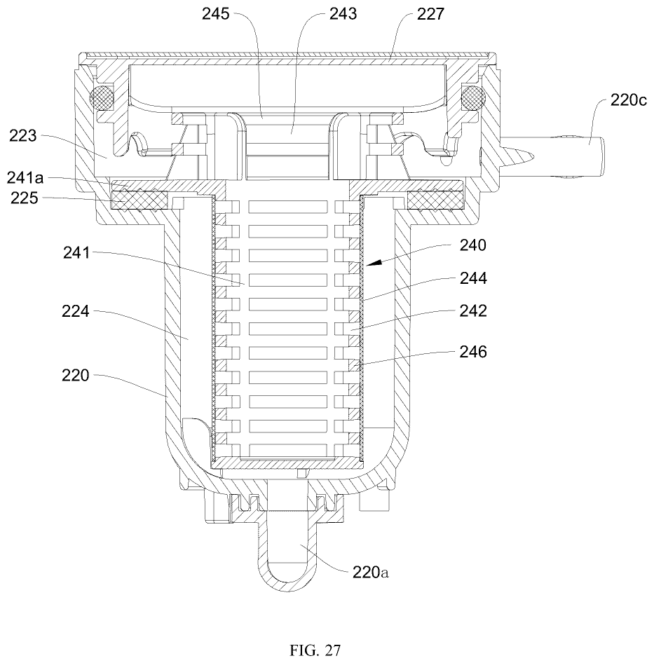

In another embodiment of the present application, as shown in FIG. 27, the sewage processing device 220 is provided with a filter assembly 240. As shown in FIGS. 25 to 27, an external portion of the sewage processing device 220 is provided with the sewage inlet 220a in communication with an internal portion of the sewage processing device 220, and the sewage inlet 220a is in communication with the third connecting port 960 of the sewage access control device 900. The external sewage is input from the first connecting port 940 into the sewage channel 930 of the sewage access control device 900, and is input into the sewage processing device 220 through the third connecting port 960 and the sewage inlet 220a. The filter assembly 240 is used to filter the sewage input into the sewage processing device 22, and the filter assembly 240 can filter impurities such as large dust and sludge in sewage.

As shown in FIGS. 25 to 27, external clear water enters the sewage processing device 220 to clean the filter assembly 240, and flushes away impurities such as large dust and sludge attached to the filter assembly 240. The cleaned sewage is discharged outward from the second connecting port 950 through the sewage inlet 220a and the third connecting port 960 and through the sewage channel 930 of the sewage access control device 900.

Preferably, as shown in FIGS. 20 and 25, the sewage access control device 900 is arranged on the side of sewage inlet 220a of the sewage processing device 220, which facilitates the connection of the third connecting port 960 with sewage inlet 220a and has a compact structure.

In the specific embodiment, as shown in FIGS. 24, 25 and 27, the sewage processing device 220 is provided with an upper receiving chamber 223 and a lower receiving chamber 224 that are in communication with each other, and a filter assembly 240 is arranged between the upper receiving chamber 223 and the lower receiving chamber 224, and the filter assembly 240 separates the upper receiving chamber 223 and the lower receiving chamber 224. The lower receiving chamber 224 is in communication with the sewage inlet 220a, and the external sewage enters the lower receiving chamber 224 through the first connecting port 940, the sewage channel 930, the third connecting port 960, and the sewage inlet 220a into the upper receiving chamber 223 through the filter assembly 240, so as to filter the sewage through the filter assembly 240. The sewage flows from the bottom to top for filtration, so that the subsequent filtered sewage can flow out directly under the action of gravity and facilitate the subsequent flushing of the filter assembly 240.

As shown in FIGS. 20, 25 and 27, the outer wall of the sewage processing device 220 is provided with a cleaning connecting port 220c in communication with the upper receiving chamber 223. The cleaning connecting port 220c is connected with the inlet valve, and the input end of the inlet valve can be in communication with an external water source (e.g., a faucet) to supply clear water through the external water source (e.g., a faucet), and the cleaning connecting port 220c is used to input clear water into the sewage processing device 220 to clean the filter assembly 240, the large dust, large sludge and other impurities are flushed from the filter assembly 240 fall into the lower receiving chamber 224, then the impurities are discharged to the outside from the sewage inlet 220a, the third connecting port 960, the sewage channel 930 and the sewage outlet 220b successively, so as to clean the impurities such as large dust and large sludge attached to the filter assembly 240, so that the filter assembly 240 can be used for a long time without or reduce manual cleaning.

Preferably, as shown in FIGS. 20 and 21, the inlet valve is arranged on the side of the cleaning connecting port 220c of the sewage processing device 220 to facilitate the connection of the inlet valve with the cleaning connecting port 220c and has a compact structure. Specifically, the inlet valve can be installed on the integrated casing 300a by means of screwing, clamping, etc.

As shown in FIGS. 19, 25 and 27, the sewage processing device 220 is connected with a pump 230, and the pump 230 is used to pump external sewage, so that the sewage passes through the sewage channel 930 of the sewage access control device 900, the third connecting port 960, the sewage inlet 220a, the lower receiving chamber 224, the filter assembly 240 and the upper receiving chamber 223 successively from the first connecting port 940, so that the sewage flows from the bottom to top passing through the filter assembly 240. The outer wall of the sewage processing device 220 is provided with a sewage outlet 220b in communication with the upper receiving chamber 223. The sewage outlet 220b is used to discharge the sewage filtered by the filter assembly 240 in the upper receiving chamber 223. It can be understood that the sewage outlet 220b is in communication with the sewage connecting port of the water exchange base station 30, and the sewage connecting port can discharge the sewage to the pool, the toilet or the floor drain and other places to discharge the sewage. The filter assembly 240 can filter impurities such as large dust and sludge in the sewage, so that the filtered sewage will not cause blockage or damage to the pump 230 when it passes through the pump 230.

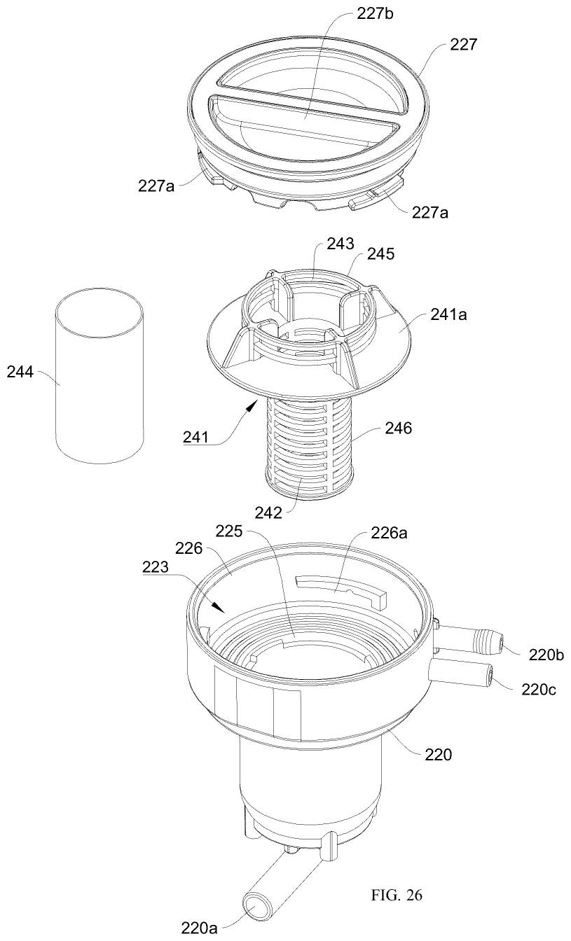

In an embodiment of the present application, as shown in FIGS. 26 and 27, the filter assembly 240 includes a filter layer 244 through which water can pass through and a support structure 241 arranged within the filter layer 244. The support structure 241 can be installed inside the sewage processing device 220 by clamping, bonding, or screwing, etc., which is not limited herein. The lower portion of the support structure 241 is provided with a plurality of first through grooves 242, the filter layer 244 covers the plurality of first through grooves 242, and the first through grooves 242 are used for the sewage filtered by the filter layer 244 to input into the support structure 241; the upper portion of the support structure 241 is provided with a plurality of second through grooves 243, the second through grooves 243 are used to output the filtered sewage from the support structure 241 into the sewage outlet 220b of the sewage processing device 220, so that the sewage can be discharged from the sewage outlet 220b after the sewage is filtered by the filter layer 244, and the filtration effect is full. When the filter layer 244 is flushed, the clear water enters the upper receiving chamber 223 from the cleaning connecting port 220c, passes through enters the second through grooves 243 to enter the support structure 241, and then passes through a plurality of first through grooves 242 to jet into the filter layer 244 to flush the large dust and sludge attached to the filter layer 244, and the flushing effect is good. As shown in FIGS. 24, 25 and 27, the impurities such as large dust and sludge flushed down fall into the lower receiving chamber 224, and finally the sewage is discharged from the second connecting port 950 through the sewage inlet 220a, the third connecting port 960 and the sewage channel 930.

The filter layer 244 can be a filter cotton, a filter net or a filter cloth, etc., which is not limited herein.

Further, as shown in FIGS. 26 and 27, the upper portion of the support structure 241 is provided with a positioning portion 245 located in the upper receiving chamber 223, the side surface of the positioning portion 245 is provided with the second through grooves 243, the lower portion of the support structure 241 is provided with a support portion 246 located in the lower receiving chamber 224, and the filter layer 244 is fixed on the side wall of the support portion 246, which is convenient for the filter layer 244 being installed on the support structure 241, and the side surface of the support portion 246 is provided with the first through grooves 242 penetrating through the support portion 246, which is convenient for the filter layer 244 covering the first through grooves 242, and the assembly is convenient.

In embodiments of the present application, as shown in FIGS. 26 and 27, the interior of the sewage processing device 220 is provided with a mounting ring 225 between the upper receiving chamber 223 and the lower receiving chamber 224, the support structure 241 is arranged through the ring hole of the mounting ring 225, and a step 241a convexly arranged at the middle of the supporting structure 241 is abutted against the mounting ring 225. Thus, the support structure 241 is installed inside the sewage processing device 220.

In the embodiments of the present application, as shown in FIGS. 26 and 27, the outer wall of the sewage processing device 220 is provided with an opening 226 in communication with the interior of the sewage processing device 220, the opening 226 is larger than the filter assembly 240, the filter assembly 240 can be detachably installed inside the sewage processing device 220 from the opening 226, and a tank cover 227 is detachably covered on the opening 226. After the filter assembly 240 is used for a period of time, the user takes off the tank cover 227, and the filter assembly 240 can be removed from the interior of the sewage processing device 220 through the opening 226, which is convenient for the user to clean and replace the filter assembly 240 at any time.

In the specific embodiments, as shown in FIGS. 26 and 27, the inner wall of the opening 226 is provided with a plurality of slots 226a, and the outer wall of the tank cover 227 is provided with a plurality of protrusions 227a, and the user can rotate the tank cover 227 forward to engage the plurality of protrusions 227a into the plurality of slots 226a one by one, so as to fit the tank cover 227 to the opening 226. When user reverse rotates the tank cover 227, the protrusions 227a and the slots 226a are free from engagement, so that the tank cover 227 can be removed from the opening 226, the structure is simple, the operation is convenient, and which has high practicability.

Further, as shown in FIGS. 26 and 27, the top of the tank cover 227 is provided with a rotating portion 227b, which is convenient for the user to twist the tank cover 227, the operation is easy.

In some embodiments, the tank cover 227 can be connected directly to the opening 226 by a buckle, which is simpler in structure and lower in cost than by a rotary connection.

As shown in FIGS. 20 and 21, the integrated mechanism also includes a pressure reducing valve 320 arranged on the integrated casing 300a. The pressure reducing valve 320 is connected to the input end of the inlet valve (e.g., the three-way valve 310) to reduce the water pressure of the input clear water. It can be understood that the input end of the inlet valve can be in communication with an external water source (e.g., a faucet) through the clear water connecting port of the water exchange base station 30 (for example, including the first clear water connecting port 202). The water pressure of the faucet is generally larger, and the water pressure of the input clear water is reduced by the pressure reducing valve 320.

Preferably, as shown in FIGS. 20 and 21, the pressure reducing valve 320 is arranged on the side of the input end of the inlet valve to facilitate the connection between the pressure reducing valve 320 and the input end of the inlet valve, and the structure is compact. Specifically, the pressure reducing valve can be installed on the integrated casing 300a by means of screwing, clamping, etc.

As shown in FIGS. 19 and 20, the integrated mechanism further includes a multi-way pipe 330 arranged on the integrated casing 300a. The multi-way pipe 330 is provided with a first water connecting port 331, a second water connecting port 332 and a drainage connecting port 334 that are in communication with each other. The first water connecting port 331 is connected to the second connecting port 950 of the sewage access control device 900 for discharging sewage after flushing the filter assembly 240 in the sewage processing device 220. The second water connecting port 332 is connected to the sewage processing device 220 for discharging the sewage filtered by the filter assembly 240. The drainage connecting port 334 is used to discharge the water input into the multi-way pipe 330. It can be understood that the drainage connecting port 334 is connected to the sewage connecting port of the water exchange base station 30 through the water pipe, and the water input into the multi-way pipe 330 is discharged to the pool, the toilet or the floor drain and other places through the sewage connecting port. Alternatively, the drainage connecting port 334 directly discharges the water input into the multi-way pipe 330 to the pool, the toilet or the floor drain through the water pipe, which does not need to connect the sewage connecting port of the water exchange base station 30. The multi-way pipe 330 is arranged to facilitate the connection of the multi-way pipe 330 with the sewage access control device 900 and the sewage processing device 220, and facilitate the discharge of excess sewage from the water exchange base station 30.

Further, as shown in FIGS. 19 and 20, the multi-way pipe 330 further includes a third water connecting port 333. The third water connecting port 333 is in communication with the first water connecting port 331, the second water connecting port 332 and the drainage connecting port 334. The third water connecting port 333 can be connected with the first clear water tank 210 through the water pipe for discharging the excess clear water in the first clear water tank 210. The multi-way pipe 330 is arranged to facilitate the connection between the multi-way pipe 330 and the first clear water tank 210 by using a water pipe, and to facilitate the discharge of excess clear water in the first clear water tank 210.

Specifically, as shown in FIGS. 20 and 21, the multi-way pipe 330 can be installed on the integrated casing 300a by means of screwing, clamping, etc.

As shown in FIGS. 19, 20 and 21, the inlet valve is a three-way valve 310, and the three-way valve 310 is provided with a inlet port 311, a first outlet port 312 and a second outlet port 313. The inlet port 311 can be in communication with an external water source (e.g., a faucet) through a clear water connecting port (e.g., including a first clear water connecting port 202) of the water exchange base station 30. The first outlet port 312 is in communication with the cleaning connecting port 220c of the sewage processing device 220, and the second outlet port 313 is in communication with the clear water inlet 212 of the first clear water tank 210. The three-way valve 310 is used to control the clear water to enter into the sewage processing device 220 from the inlet port 311 and the first outlet port 312 successively to flush the filter assembly 240 of the sewage processing device 220 to realize the cleaning of the filter assembly 240. Alternatively, the three-way valve 310 is used to control the clear water input from the inlet port 311 and the second outlet port 313 successively to replenish the water to the first clear water tank 210 to realize the water supply to the first clear water tank 210.

In another embodiment of the present application, as shown in FIGS. 18 and 19, a water exchange base station 30 is further provided for docking with an intelligent cleaning machine. The water exchange base station 30 includes the main body 300 and the integrated mechanism mentioned above. The main body 300 is provided with a sewage connecting port and a clear water connecting port, the main body 300 is provided with a first clear water tank 210 and the integrated mechanism mentioned above.

Specifically, as shown in FIGS. 19 and 21, the clear water connecting port of the water exchange base station 30 can include the first clear water connecting port 202 and the clear water exchange port 102, and the inlet port 311 of the inlet valve can be in communication with the first clear water connecting port 202, that is, the first clear water connecting port 202 is used as the clear water inlet, and the first clear water connecting port 202 is in communication with the external water source (e.g. a faucet) and is used to input clear water into the water exchange base station 30 to flush the sewage processing device 220 or to replenish clear water to the first clear water tank 210. Alternatively, the first clear water tank 210 can be in communication with the clear water exchange port 102, that is, at this time, the clear water exchange port 102 is used as the clear water outlet, and the clear water exchange port 102 is used for docking with the intelligent cleaning machine, so that the clear water in the first clear water tank 210 can replenish the clear water to the intelligent cleaning machine through the clear water exchange port 102.

Specifically, as shown in FIGS. 19 and 25, the sewage connecting port of the water exchange base station 30 can include the first sewage connecting port 201 and the sewage exchange port 101. The first connecting port 940 of the sewage access control device 900 can be in communication with the sewage exchange port 101, that is, at this time, the sewage exchange port 101 is used as the sewage inlet, and the sewage exchange port 101 is used to dock with the intelligent cleaning machine, such that the sewage inside the intelligent cleaning machine is input into the sewage processing device 220 from the sewage exchange port 101 through the sewage access control device 900. Alternatively, the sewage outlet 220b of the sewage processing device 220 can be in communication with the sewage exchange port 101, that is, at this time, the first sewage connecting port 201 is used as the sewage outlet, and the first sewage connecting port 201 is used to discharge the sewage processed (filtered) by the sewage processing device 220. Alternatively, the second connecting port 950 of the sewage access control device 900 can be in communication with the first sewage connecting port 201, that is, at this time, the first sewage connecting port 201 is used as the sewage outlet, and the first sewage connecting port 201 is used to discharge the sewage in the sewage processing device 220 after flushing the sewage processing device 220 through the filter assembly 240.

In some embodiments, as shown in FIGS. 19 and 21, the first clear water connecting port 202 is used to connect with an external water source (e.g. a faucet) to input the clear water into the water exchange base station 30, and the inlet port 311 of the inlet valve can be in communication with the first water connecting port 202 for inputting clear water, as shown in FIGS. 19, 21 and 27, the clear water is input into the sewage processing device 220 to flush the filter assembly 240 of the sewage processing device 220 from the first water connecting port 202, the inlet port 311, the first outlet port 312 and the cleaning connecting port 220c successively. Alternatively, the clear water is replenished from the first water connecting port 202, the inlet port 311 and the second outlet port 313 to the first water tank 210. The first clear water tank 210 can be in communication with the clear water exchange port 102, and the clear water exchange port 102 is used for docking with the intelligent cleaning machine to replenish clear water to the intelligent cleaning machine.

In some embodiments, as shown in FIGS. 19 and 25, the sewage access control device 900 is in communication with both the sewage exchange port 101 and the first sewage connecting port 201, for example: the first connecting port 940 of the sewage access control device 900 can be in communication with the sewage exchange port 101, and the second connecting port 950 of the sewage access control device 900 can be in communication with the first sewage connecting port 201; the sewage exchange port 101 is used for docking with the intelligent cleaning machine, so that the sewage inside the intelligent cleaning machine is input into the sewage processing device 220 from the sewage exchange port 101, the first connecting port 940, the sewage channel 930, the third connecting port 960 and the sewage inlet 220a successively, and the first sewage connecting port 201 is used to discharge the sewage in the sewage processing device 220. The sewage after flushing the filter assembly 240 is discharged from the sewage inlet 220a, the third connecting port 960, the sewage channel 930, the second connecting port 950 and the first sewage connecting port 201 successively.

As shown in FIGS. 19, 25 and 27, the sewage outlet 220b of the sewage processing device 220 is connected to the first sewage connecting port 201 for discharging the sewage filtered by the filter assembly 240. Specifically, the sewage filtered by the filter assembly 240 is discharged from the sewage outlet 220b and the first sewage connecting port 201 successively.

Further, as shown in FIGS. 18 and 19, the main body 300 is provided with a docking connector 160 convexly arranged at a side of the sewage exchange port 101(sewage inlet) or the clear water exchange port 102 (clear water outlet), the docking connector 160 is used for positioning and docking the intelligent cleaning machine. Specifically, the intelligent cleaning machine (not shown) is provided with a docking slot, and the docking connector 160 is inserted into the docking slot of the intelligent cleaning machine to dock with the intelligent cleaning machine. By positioning (limiting) the intelligent cleaning machine through the docking connector 160, the water exchange base station 30 does not need to wrap a large semicircle of the intelligent cleaning machine, and the volume of the water exchange base station 30 can be reduced.

Further, as shown in FIGS. 18 and 19, a surface of a side of the main body located at the sewage exchange port 101(sewage inlet) or the clear water exchange port 102 (clear water outlet) is concavely provided with a docking surface 530, and the docking surface 530 is an arc surface for fitting the outer arc of the intelligent cleaning machine. In other embodiments, the docking surface 530 can also be a flat surface.

In another embodiment of the present application, as shown in FIGS. 18 and 19, the outer wall of the first clear water tank 210 is provided with a clear water inlet 212 and a clear water outlet 211 that are in communication with the interior of the first clear water tank 210, the second outlet port 313 of the inlet valve (e.g. the three-way valve 310) is in communication with the clear water inlet 212 for controlling the clear water to input through the clear water inlet 212 to replenish the clear water to the first water tank 210. The clear water outlet 211 is in communication with the clear water exchange port 102 (clear water outlet) and is used to replenish the clear water in the first clear water tank 210 to the intelligent cleaning machine through the clear water exchange port 102 when the clear water exchange port 102 is docked with the intelligent cleaning machine.

As shown in FIGS. 19 and 28, the clear water outlet 211 is connected to a three-way pipe 440, the three-way pipe 440 is provided with a first pipe port 441, a second pipe port 442 and a third pipe port 443 that are in communication with each other, and the first pipe port 441 of three-way pipe 440 is connected with a air replenish valve, the air replenish valve is used to control the water pressure of the clear water outlet 211 and prevent siphon. The second pipe port 442 of the three-way pipe 440 is in communication with the clear water outlet 211, and thus is in communication with the interior of the first clear water tank 210. The third pipe port 443 of the three-way pipe 440 is in communication with the clear water exchange port 102 (clear water outlet) and replenishes clear water to the intelligent cleaning machine through the clear water exchange port 102.

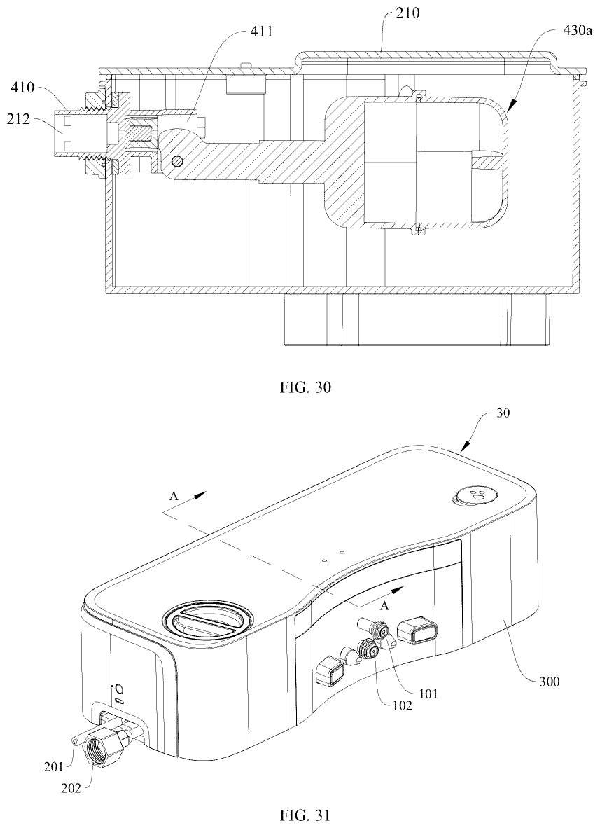

As shown in FIGS. 21, 28 and 30, the first clear water tank 210 is provided with a quick connector 410, which is convenient to connect with the water pipe. For example, the quick connector 410 can be quickly connected to the second outlet port 313 of the inlet valve in the water exchange base station 30 through the water pipe, or the quick connector 410 can be quickly connected to an external water source (for example, a faucet) through the water pipe. As shown in FIGS. 28 and 30, a first end of the quick connector 410 is the clear water inlet 212, and a second end of quick connector 410 is provided with an inlet channel 411, the inlet channel 411 is in communication with the interior of the first clear water tank 210, and the clear water inlet 212 and the inlet channel 411 can be in communication with each other to make external clear water enter the first clear water tank 210. Thus the clear water is replenished to the first clear water tank 210.

As shown in FIGS. 28 to 30, a water volume control device 430a is provided in the first clear water tank 210, and an end of the water volume control device 430a is movably connected to the inlet channel 411. When the clear water in the first clear water tank 210 reaches the preset degree (the preset degree is the water tank full or near the water tank full according to the capacity of the water tank), the water volume control device 430a blocks the inlet channel 411 so that the clear water is prevented from entering the first clear water tank 210, to prevent the first clear water tank 210 from being too full and spilling out, and the structure is reliable.

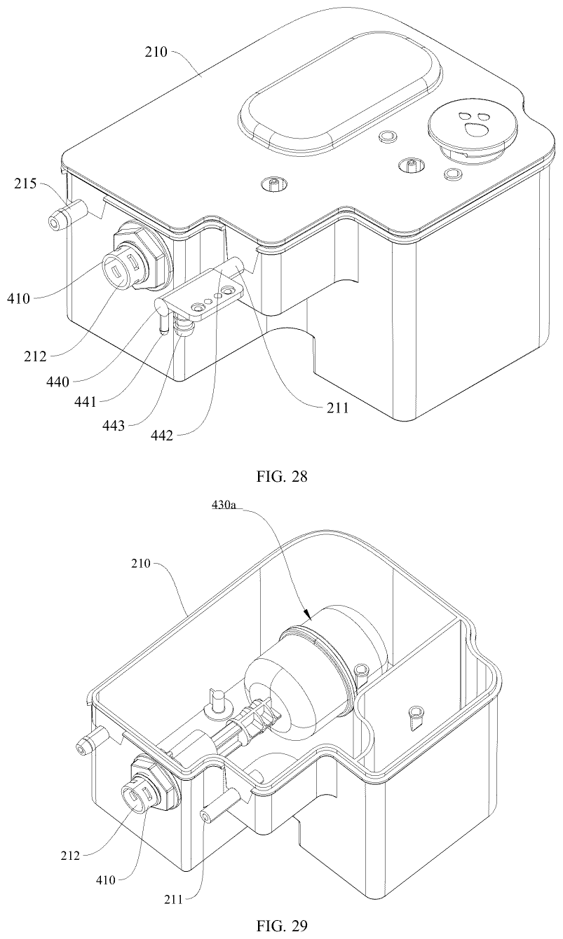

As shown in FIGS. 19 and 29, the first clear water tank 210 is provided with an overflow outlet 215 in communication with the interior of the first clear water tank 210, the overflow outlet 215 is used to discharge excess clear water in the first clear water tank 210 to prevent the clear water leakage caused by excessive clear water in the first clear water tank 210. Specifically, the overflow outlet 215 can discharge the overflow clear water through the water pipe to the pool, the toilet or the floor drain and other places, and the structure is simple. In the specific embodiment, the overflow outlet 215 is connected to the third water connecting port 333 of the multi-way pipe 330 through the water pipe, and the excess clear water in the first clear water tank 210 flows into the multi-way pipe 330 and is discharged outward through the drainage connecting port 334.

As shown in FIGS. 31 to 36, in one embodiment of the present application (i.e., Embodiment 3), the water exchange base station 30 includes a main body 300, a first control module 700, and a water level detection member 800.

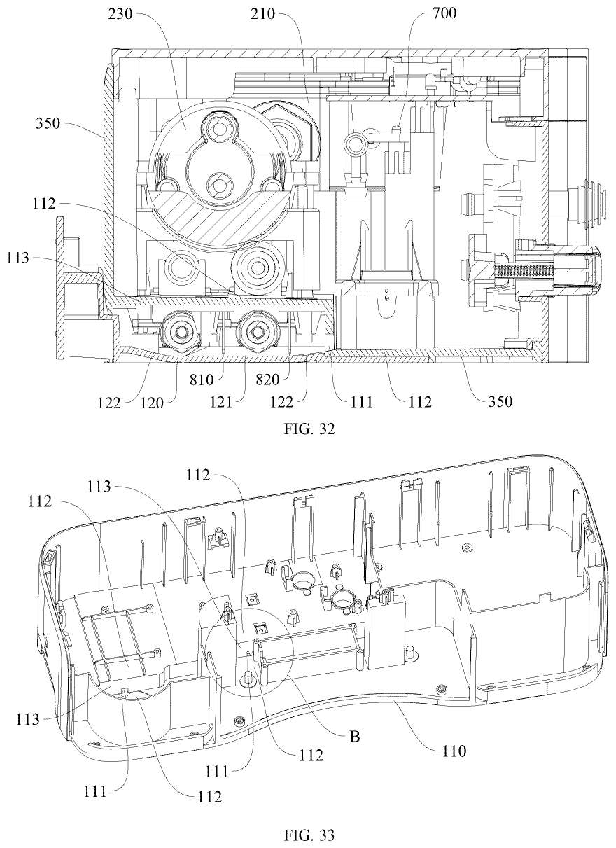

As shown in FIG. 32, the bottom of the main body 300 is provided with a water collection groove 121, and the water collection groove 121 is used for collecting water leaking out of the main body 300. The water leakage can be caused by water leaking from the first clear water tank 210, the sewage processing device 220, or pump 230 and other devices located inside the main body 300.

As shown in FIG. 32, the first control module 700 is located in main body 300.

As shown in FIGS. 32 and 33, the water level detection member 800 is at least partially arranged in the water collection groove 121 and electrically connected to the first control module 700. When the water level in the water collection groove 121 spreads to the water level detection member 800, the water level detection member 800 detects water leakage, and the water level detection member 800 feed-back the electrical signal to the first control module 700 to control the water exchange base station 30 to stop the corresponding work, the corresponding work can include all the work or part of the water exchange work to remind the user that the water exchange base station is leaking. It is necessary to check the water exchange base station in time to ensure the risk of electric shock from being found in time, and the safety is high.

In another embodiment of the present application, as shown in FIGS. 32, 35, and 36, the main body 300 includes a housing 350, a water device, and a bottom cover 360. The bottom cover 360 can be integrated with the housing 350, or the bottom cover 360 is fixedly connected or detachably connected with the housing 350. The bottom cover 360 is arranged at the bottom of the housing 350, and the water collection groove 121 is arranged above the bottom cover 360. The bottom wall of the housing 350 is provided with at least one diversion port 111, which is in communication with the water collection groove 121, and the water leaking from the main body 300 flows into the bottom cover 360 through the diversion port 111 and gathers in the water collection groove 121. The water collection groove 121 being arranged above the bottom cover 360 is convenient to remove the bottom cover 360 to check or discharge the water in the water collection groove 121 after removing the fault, which is easy to operate.

In one embodiment, as shown in FIG. 36, the bottom wall of the housing 350 is provided with a plurality of diversion ports 111, the plurality of diversion ports 111 increase the efficiency of water leakage into the water collection groove 121 of the bottom cover 360.

As shown in FIGS. 33 and 36, the bottom wall of the housing 350 is provided with a first incline surface 112 inclined from an edge of the bottom wall towards the diversion port 111, the water leaking from the interior of the main body 300 falls on the bottom wall of the housing 350, the leakage water is gathered to the diversion port 111 by the first incline surface 112, and then flows to the water collection groove 121 of the bottom cover 360 from the diversion port 111. The first incline surface 112 plays a confluence role to prevent the bottom wall of the housing 350 from gathering water.

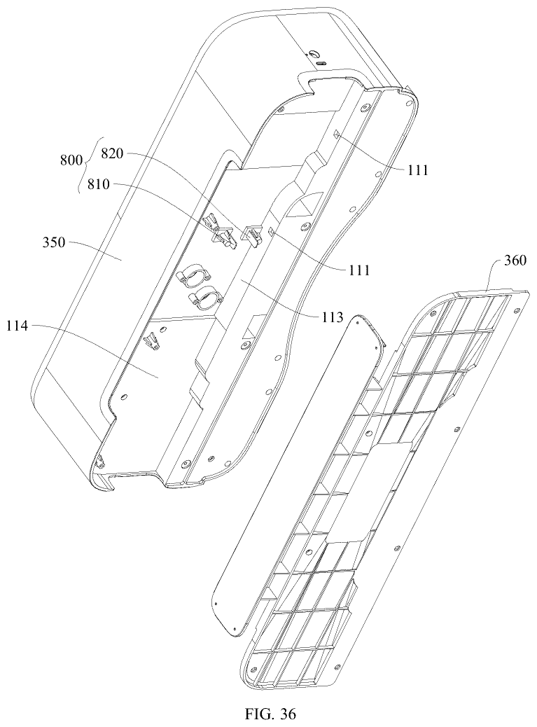

As shown in FIG. 35, the bottom wall of a side of the housing 350 is raised to form a step 113, and the bottom cover 360 is arranged in a notch 114 arranged on a side of the step 113, which makes reasonable use of the space of the housing 350, and the bottom of the bottom cover 360 is flush with the bottom of the housing 350, so as to facilitate the stable placement of the main body 300.

As shown in FIGS. 32, 35 and 36, the diversion port 111 is located at or near the joint between the side wall of the step 113 and the bottom wall of the other side of the housing 350, and the step surface of the step 113 forms the first incline surface 112 inclined from an edge of the step 113 towards the diversion port 111, the water leaking from the interior of the main body 300 falling on the step surface of the step 113 is gathered to the diversion port 111 by the first incline surface 112, and then flows to the water collection groove 121 of the bottom cover 360 from the diversion port 111, so as to prevent the step surface of the step 113 from gathering water. The bottom wall of the other side of the housing 350 is provided with a first incline surface 112 inclined from an edge of the bottom wall of the other side towards the diversion port 111, the water leaking from the interior of the main body 300 falling on the bottom wall of the other side of the housing 350 is gathered to the diversion port 111 by the first incline surface 112, and then flows to the water collection groove 121 of the bottom cover 360 from the diversion port 111, so as to prevent the bottom wall of the other side of the housing 350 from gathering water.

In another embodiment of the application, as shown in FIGS. 32 and 35, an upper surface of the bottom cover 360 is provided with a second incline surface 122 inclined from a periphery of the upper surface towards to the water collection groove 121, the leakage water flows to the upper surface of the bottom cover 360 from the diversion port 111, and the leakage water is gathered rapidly towards the water collection groove 121 through the second incline surface 122. The second incline surface 12 plays a confluence role.

Further, as shown in FIGS. 35 and 36, the water collection groove 121 is located in the middle of the upper surface of the bottom cover 360, and the upper surface of the bottom cover 360 is provided with second incline surfaces 122 on all sides of the water collection groove 121. The leakage water flowing into the upper surface of the bottom cover 360 is rapidly gathered into the water collection groove 121 through the second incline surfaces 122, and the confluence effect is good.

In another embodiment of the present application, as shown in FIGS. 32 and 36, the water level detection member 800 includes a positive probe 810 and a negative probe 820 that are electrically connected to the first control module 700. The positive probe 810 and the negative probe 820 are symmetrical and spaced apart, and the lower ends of the positive probe 810 and the negative probe 820 are at least partially extended into the water collection groove 121. When the water level in the water collection groove 121 spreads to the lower ends of the positive probe 810 and the negative probe 820, water acts as the conductive medium, and the positive probe 810 and the negative probe 820 are conductive to form a loop, and the electrical signal is fed back to the first control module 700 to control the water exchange base station to stop corresponding work and realize water leakage detection.

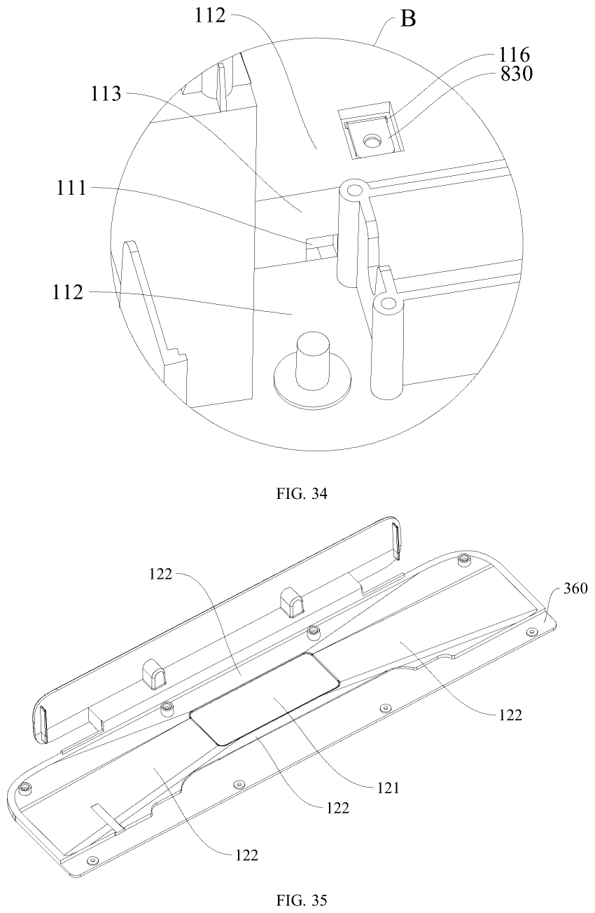

Further, as shown in FIGS. 32 and 34, the upper ends of both the positive probe 810 and the negative probe 820 are bent to form a mounting portion 830, and the mounting portion 830 is fixed to the bottom of the housing 350 of the main body 300. In particular, two through holes 116 are symmetrically arranged at the bottom of the housing 350, and the upper ends of the positive probe 810 and the negative probe 820 are respectively arranged penetrating through the two through holes 116, and the mounting portion 830 is fixed at the bottom of the housing 350 by clamping, bonding, or screwing, etc.

In another embodiment of the present application, a water exchanging method of a water exchange base station is further provided, which is applied to the water exchange base station 30, the main body 300 of the water exchange base station 30 is provided with a second control module and a first detection module, and the second control module is electrically connected with the first detection module; and the method includes the following steps:

In step S11, detecting whether the water exchange base station 30 and the intelligent cleaning machine 40 are properly docked in place base on the first detection module.

As shown in FIGS. 3 and 16, the above docking in place means that when the intelligent cleaning machine 40 enters the state of exchanging water, the intelligent cleaning machine 40 moves to the water exchange base station 30 through the guidance of the map or position detection sensor, so that the sewage exchange port 101 of the water exchange base station 30 and the sewage port 45 of the intelligent cleaning machine 40 are docked in place; and/or the clear water exchange port 102 of the water exchange base station 30 is docked in place with the clear water port 44 of the intelligent cleaning machine 40, and/or the charging connector 150 of the water exchange base station 30 is docked in place with the charging portion 47 of the intelligent cleaning machine 40.

In step S12, supplying water to the clear water port 44 of the intelligent cleaning machine 40 through the clear water exchange port 102 and/or collecting water from the sewage port 45 of the intelligent cleaning machine 40 through the sewage exchange port 101 of the water exchange base station 30 based on the second control module located in the water exchange base station 30.

The first clear water connecting port 202 of the water exchange base station 30 is used to connect the external water source, and then supplies clear water to the clear water port 44 of the intelligent cleaning machine 40 through the clear water exchange port 102 of the water exchange base station 30. The water exchange base station 30 turns on the inlet valve to control the clear water entering the water exchange base station 30 or the intelligent cleaning machine 40. The whole process can be automatically fed and discharge water to the intelligent cleaning machine 40 through the water exchange base station 30 to improve the user experience.

The water exchange base station 30 collects sewage from the sewage port 45 of the intelligent cleaning machine 40 through the sewage exchange port 101, and then discharges sewage to the outside through the first sewage connecting port 201 of the water exchange base station 30; the pump 230 of the water exchange base station 30 draws out the sewage from the intelligent cleaning machine 40 through the sewage exchange port 101; the whole process can automatically discharge the sewage of the intelligent cleaning machine 40 through the water exchange base station 30 to improve the user experience.

In step S13, controlling to stop supplying water supply and/or collecting water based on the second control module according to the preset time or the detection information from the intelligent cleaning machine 40.

The water exchange base station 30 and the intelligent cleaning machine 40 are supporting equipment. In the factory setting, the water exchange base station 30 can set the first preset time for filling up the clear water in the second clear water tank 42 of the intelligent cleaning machine 40, and the second preset time for draining the sewage in the sewage tank 43 of the intelligent cleaning machine 40. In the process of supplying water, the water exchange base station 30 supplies clear water to the intelligent cleaning machine 40 according to the first preset time, and when the first preset time is reached, the water exchange base station 30 stops supplying clear water; during the water collection process, the water exchange base station 30 collects the sewage of the intelligent cleaning machine 40 according to the second preset time, and when the second preset time is reached, the water exchange base station 30 stops collecting the sewage of the intelligent cleaning machine 40.

In another embodiment, when the water exchange base station 30 supplies the clear water to the intelligent cleaning machine 40, the second clear water tank 42 of the intelligent cleaning machine 40 is provided with a clear water sensor. When the clear water sensor detects that the clear water in the second clear water tank 42 has been filled, the intelligent cleaning machine 40 sends a first detection information (the second clear water tank 42 is full) to the water exchange base station 30, and the water exchange base station 30 stops supplying clear water to the intelligent cleaning machine 40 according to the first detection information from the intelligent cleaning machine 40; in the process that the water exchange base station 30 collects sewage from the intelligent cleaning machine, the sewage tank 43 of the intelligent cleaning machine 40 is provided with a sewage sensor, when the sewage sensor detects that the sewage in the sewage tank 43 has been evacuated, the intelligent cleaning machine 40 sends a second detection information (sewage tank 43 has been evacuated) to the water exchange base station 30, and the water exchange base station 30 stops collecting sewage from the intelligent cleaning machine 40 according to the second detection information from the intelligent cleaning machine 40.

It should be noted that the water supply means that the water exchange base station 30 supplies clear water to the intelligent cleaning machine 40, and the water collection means that the water exchange base station 30 collects sewage from the intelligent cleaning machine 40 (that is, the water exchange base station 30 to draw out the sewage in the intelligent cleaning machine 40).

The water exchange method of the water exchange base station can realize the automatic docking of the water exchange base station 30 and the intelligent cleaning machine 40 to carry out automatic water exchanging.

In another embodiment of the present application, as shown in FIGS. 1, 16 and 17, an intelligent cleaning machine 40 is further provided for automatic docking with a water exchange base station 30, the intelligent cleaning machine 40 includes a shell 41, and a second clear water tank 42 and a sewage tank 43 arranged inside the shell 41. The shell 41 is provided with a clear water port 44 in communication with the second clear water tank 42 and a sewage port 45 in communication with the sewage tank 43. The sewage port 45 is used for docking with the sewage exchange port 101 of the water exchange base station 30 to discharge sewage to the outside through the water exchange base station 30, and the clear water port 44 is used for docking with the clear water exchange port 102 of the water exchange base station 30 to connect the external water source through the water exchange base station 30 and supply clear water to the intelligent cleaning machine 40 for automatic water exchanging.

The shell 41 can further provide with a gray water port 46 in communication with the second clear water tank 42 or the sewage tank 43.

In other embodiments, the intelligent cleaning machine 40 can further be provided with a gray water tank (not shown), which is a different tank from the sewage tank 43 used to store the sewage in the intelligent cleaning machine 40 or the second clear water tank 42 used to store clear water, and the gray water port 46 of the intelligent cleaning machine 40 is in communication with the gray water tank of the intelligent cleaning machine 40.

Further, as shown in FIGS. 1, 16 and 17, the shell 41 is provided therein with a rechargeable battery (not shown) for charging the intelligent cleaning machine 40. The charging portion 47 is arranged on the shell 41, and the rechargeable battery of the intelligent cleaning machine 40 is electrically connected with the charging portion 47. The charging portion 47 can be fitted with the charging connector 150 of the water exchange base station 30 to form conductivity. When the charging portion 47 is docked with the charging connector 150 of the water exchange base station 30, the charging portion 47 is used to supply power to the pump 230 of the water exchange base station 30 to ensure the operation of the pump 230.

Further, as shown in FIGS. 1, 16 and 17, the shell 41 is provided therein with a cleaning machine pump 48, which is connected to the second clear water tank 42 through a water pipe. During operation, the cleaning machine pump 48 is used to draw out the clear water in the water exchange base station 30 through the clear water port 44 and input the clear water into the second clear water tank 42, so as to replenish water to the intelligent cleaning machine 40.

Further, as shown in FIGS. 1, 16 and 17, the shell 41 is further provided with a third control module and a second detection module, and the third control module is electrically connected to the second detection module. The sewage tank 43 is provided with a sewage sensor (not shown) for detecting whether the sewage is full, and the second clear water tank 42 is provided with a clear water sensor (not shown) for detecting whether the clear water is empty.

The third control module is used to control the intelligent cleaning machine 40 to enter the state of water exchanging and move to the water exchange base station 30 for automatic water exchanging after the sewage sensor detects that the sewage in the sewage tank 43 is full or the clear water sensor detects that the clear water in the second clean tank 42 is empty.

The second detection module is used to detect the location of the water exchange base station 30 under the state of water exchanging of the intelligent cleaning machine 40, so as to ensure the docking of the sewage port 45 of the intelligent cleaning machine 40 with the sewage exchange port 101 of the water exchange base station 30 and/or the clear water port 44 of the intelligent cleaning machine 40 with the clear water exchange port 102 of the water exchange base station 30. Thus, the intelligent cleaning machine 40 can be accurately docked with the water exchange base station 30.

The third control module is further used to control the start and stop of drainage and/or taking water according to the preset time, information from the water exchange base station 30 or the detection information from the intelligent cleaning machine 30 after the intelligent cleaning machine 40 and the water exchange base station 30 are docked in place.

It should be noted that the water exchange base station 30 and the intelligent cleaning machine 40 are supporting equipment. In the factory setting, the third control module can set the third preset time for filling up the clear water in the second clear water tank 42 of the intelligent cleaning machine 40, and the third control module can also set the fourth preset time for draining out the sewage in the sewage tank 43 of the intelligent cleaning machine 40. In the process of taking water, the third control module takes clear water from the water exchange base station 30 according to the third preset time, and when the third preset time is reached, the third control module controls the intelligent cleaning machine 40 to stop taking clear water. In the process of drainage, the third control module discharges sewage to the water exchange base station 30 according to the fourth preset time, and when the fourth preset time is reached, the third control module controls the intelligent cleaning machine 40 to stop discharging sewage to the water exchange base station.

In another embodiment, the water exchange base station 30 can set the first preset time for filling up the clear water in the second clear water tank 42 of the intelligent cleaning machine 40, and the water exchange base station 30 can further set the second preset time for evacuating the sewage in the sewage tank 43 of the intelligent cleaning machine 40. In the process of taking water, when the first preset time is reached, the water exchange base station 30 sends the information to the third control module of the intelligent cleaning machine 40, and the third control module stops taking clear water from the water exchange base station 30 according to the information from the water exchange base station 30. In the process of drainage, when the second preset time is reached, the water exchange base station 30 sends the information to the third control module of the intelligent cleaning machine 40, and the third control module stops discharging sewage to the water exchange base station 30 according to the information from the water exchange base station 30.

In other embodiments, when the intelligent cleaning machine 40 is taking clear water from the water exchange base station 30, the second clear water tank 42 of the intelligent cleaning machine 40 is provided with a clear water sensor. When the clear water sensor detects that the clear water in the second clear water tank 42 has been filled, the intelligent cleaning machine 40 stops taking clear water from the water exchange base station 30 according to the first detection information (the second clear water tank 42 is full); in the process of discharging sewage to the water exchange base station 30 from the intelligent cleaning machine 40, the sewage tank 43 of the intelligent cleaning machine 40 is provided with a sewage sensor, and when the sewage sensor detects that the sewage in the sewage tank 43 has been evacuated, the intelligent cleaning machine 40 stops discharging sewage to the water exchange base station 30 according to the second detection information (the sewage tank 43 has been evacuated).

In another embodiment of the present application, a water exchanging method of an intelligent cleaning machine is further provided, which is applied to the intelligent cleaning machine 40 described above, and the method includes the following steps:

In step S21, the intelligent cleaning machine 40 entering the state of water exchanging and moving to the water exchange base station 30 when the sewage sensor detects that the sewage in the sewage tank 43 of the intelligent cleaning machine 40 is full, or the clear water in the second clear water tank 42 of the intelligent cleaning machine 40 is empty.

In step S22, controlling the sewage port 45 of the intelligent cleaning machine 40 to be docked with the sewage exchange port 101 of the water exchange base station 30, and/or the clear water port 44 of the intelligent cleaning machine 40 to be docked with the clear water exchange port 102 of the water exchange base station 30.

In step S23, taking clear water from the water exchange base station 30 through the clear water port 44 of the intelligent cleaning machine 40 and/or draining sewage o the water exchange base station 30 through the sewage port 45 of the intelligent cleaning machine 40.

The first clear water connecting port 202 of the water exchange base station 30 is used to connect to the external water source, and then the clear water is taken from the water exchange base station 30 through the clear water port 44 of the intelligent cleaning machine 40. The whole process can be automatically fed and discharged to the intelligent cleaning machine 40 through the water exchange base station 30 to improve the user experience.

The sewage is discharged to the water exchange base station 30 through the sewage port 45 of the intelligent cleaning machine 40, and then the sewage is discharged to the outside through the first sewage connecting port 201 of the water exchange base station 30. The pump 230 of the water exchange base station 30 pumps the sewage from the intelligent cleaning machine 40 through the sewage exchange port 101, which facilitates the automatic discharge of the sewage in the intelligent cleaning machine 40 to the outside through the water exchange base station 30, and improves the user experience.

In step S24, stopping to take clear water and/or discharge sewage according to a preset time, information from the water exchange base station 30, or detection information from the intelligent cleaning machine 40.

After the intelligent cleaning machine 40 completes taking clear water or discharging sewage, the intelligent cleaning machine stops taking clear water or discharging sewage and moves to its working position according to the control mode of the third control module.

In the embodiment, according to the process settings of the intelligent cleaning machine 40 or the water exchange base station 30, as well as the operation instructions of the user on the APP, the intelligent cleaning machine 40 can only complete taking clear water or discharging sewage, or it can realize taking clear water and discharging sewage at the same time to save time.

In another embodiment of the present application, as shown in FIGS. 1, 16 and 17, an intelligent cleaning machine water exchange system is further provided, and the system includes the water exchange base station 30 and the intelligent cleaning machine 40. The water exchange base station 30 can automatically dock with the intelligent cleaning machine 40 for automatic water exchanging. The system can further include a cleaning base station for supplying a power to the intelligent cleaning machine 40 and collecting a dust in the intelligent cleaning machine 40, and can also automatically clean the mop of the intelligent cleaning machine 40 according to specific needs.

The rest of the embodiment is the same as that of Embodiment 1, and the features not explained in the embodiment are interpreted in Embodiment 1 and will not be repeated here.

The above are optional embodiments of the present application only and are not intended to restrict the present application. For those skilled in the art, the present application is subject to various changes and variations. Any modification, equivalent replacement, improvement, etc. made within the spirit and principles of the present application shall be included in the scope of the claims of the present application.

1. A water exchange base station, configured for automatically docking with an intelligent cleaning machine, comprising:
a main body;
a sewage exchange port, arranged on the main body and configured for docking with a sewage port of the intelligent cleaning machine;
a clear water exchange port, arranged on the main body and configured for docking with a clear water port of the intelligent cleaning machine;
a first clear water connecting port, arranged on the main body and configured for connecting with an external water source;
a first sewage connecting port, arranged on the main body and in communication with the sewage exchange port and configured for discharging a sewage to an outside; and an inlet valve, configured for controlling a clear water to enter the water exchange base station or the intelligent cleaning machine;
wherein when the clear water port of the intelligent cleaning machine is docked with the clear water exchange port and is in a state of supplying clear water, the first clear water connecting port is in communication with the clear water exchange port, and the clear water exchange port supplies the clear water to the intelligent cleaning machine; and wherein when the sewage port of the intelligent cleaning machine is docked with the sewage exchange port and is in a state of discharging sewage, the sewage in the intelligent cleaning machine is drawn out from the sewage exchange port and discharged from the first sewage connecting port to the outside.

2. The water exchange base station according to claim 1, wherein the main body is provided with a pump, when the sewage port of the intelligent cleaning machine is docked with the sewage exchange port and is in the state of discharging sewage, the pump draws out the sewage in the intelligent cleaning machine from the sewage exchanging port; the main body is provided with a sewage processing device, a sewage inlet of the sewage processing device is in communication with the sewage exchange port, and a sewage outlet of the sewage processing device is in communication with the first sewage connecting port; the sewage processing device is connected with the pump and configured for drawing out the sewage of the intelligent cleaning machine and pumping into the sewage processing device through the pump when in the state of discharging sewage.

3. The water exchange base station according to claim 2, wherein the sewage processing device is provided therein with an upper receiving chamber and a lower receiving chamber that are in communication with each other, the lower receiving chamber is connected with the sewage inlet to input the sewage into the lower receiving chamber; the upper receiving chamber is connected with the sewage outlet to discharge the sewage filtered in the upper receiving chamber; a filter assembly is provided between the upper receiving chamber and the lower receiving chamber, and the pump is configured for drawing out the sewage in the intelligent cleaning machine and guides the sewage successively passing through the lower receiving chamber, the filter assembly, and the upper receiving chamber.

4. The water exchange base station according to claim 3, wherein the filter assembly comprises a filter layer configured for a water flow to pass through and a support structure arranged in the filter layer; a lower portion of the support structure is provided with a plurality of first through grooves configured for the sewage entering into the support structure after being filtered, and an upper portion of the support structure is provided with a plurality of second through grooves configured for outputting the sewage into the sewage outlet from the support structure after being filtered.

5. The water exchange base station according to claim 4, wherein the upper portion of the support structure is provided with a positioning portion located in the upper receiving chamber, and a side surface of the positioning portion is provided with the plurality of second through grooves; the lower portion of the support structure is provided with a support portion located in the lower receiving chamber, the filter layer is fixed on the support portion, and a side surface of the support portion is provided with the plurality of first through grooves.

6. The water exchange base station according to claim 3, wherein an outer wall of the sewage processing device is provided with a cleaning connecting port in communication with the upper receiving chamber, the cleaning connecting port is in communication with first clear water connecting port through a cleaning pipe, and the cleaning connecting port is configured for inputting the clear water to clean the filter assembly.

7. The water exchange base station according to claim 3, wherein an outer wall of the sewage processing device is provided with an opening in communication with an interior of the sewage processing device, and the filter assembly is detachably installed into the interior of the sewage processing device through the opening.

8. The water exchange base station according to claim 3, wherein the main body is further provided therein with a sewage access control device in communication with the sewage processing device and configured for controlling the sewage to enter the sewage processing device, and/or for controlling the sewage to be discharged out of the sewage processing device after flushing the sewage processing device.

9. The water exchange base station according to claim 8, wherein the sewage access control device comprises a first connecting port, a second connecting port, a valve, and a third connecting port; the third connecting port is in communication with the sewage processing device, and the valve is configured for controlling the sewage to enter the sewage processing device from the first connecting port and the third connecting port, and/or for controlling the sewage to be discharged out of the third connecting port and the second connecting port successively after flushing the sewage processing device.

10. The water exchange base station according to claim 9, wherein the sewage access control device comprises a control casing; the valve comprises a first valve and a second valve; a sewage channel is arranged in the control casing, and the first connecting port, the second connecting port, and the third connecting port are arranged on an outer wall of the control casing and are in communication with the sewage channel; the first valve is arranged at the first connecting port and configured for controlling the sewage to pass through the first connecting port, the sewage channel and the third connecting port successively to enter into the sewage processing device; the second valve is arranged at the second connecting port and configured for controlling the sewage to be discharged out of the third connecting port, the sewage channel and the second connecting port successively after flushing the sewage processing device.

11. The water exchange base station according to claim 8, wherein the main body is further provided with an integrated casing; the sewage access control device, the inlet valve and the sewage processing device are arranged on the integrated casing, and the integrated casing is further provided with a multi-way pipe; the multi-way pipe is provided with a first water connecting port, a second water connecting port and a drainage connecting port that are in communication with each other; the first water connecting port is connected with the sewage access control device and configured for discharging the sewage after flushing the sewage processing device, the second water connecting port is connected with the sewage processing device and configured for discharging the sewage processed by the sewage processing device, and the drainage connecting port is configured for discharging water entering the multi-way pipe to the outside.

12. The water exchange base station according to claim 11, wherein the multi-way pipe further comprises a third water connecting port; the third water connecting port is in communication with the first water connecting port, the second water connecting port and the drainage connecting port; and the third water connecting port is connected with a first clear water tank of the water exchange base station and configured for discharging excess clear water in the first clear water tank.

13. The water exchange base station according to claim 3, wherein the inlet valve is a three-way valve, the three-way valve is provided with an inlet port, a first outlet port, and a second outlet port; the inlet port is configured for inputting the clear water, the first outlet port is in communication with the sewage processing device, the second outlet port is in communication with a first clear water tank of the water exchange base station; and the three-way valve is configured for controlling the clear water entering from the inlet port and the first outlet port successively to flush the sewage processing device, or for controlling the clear water entering from the inlet port and the second outlet port successively to replenish the clear water to the first clear water tank.

14. The water exchange base station according to claim 13, wherein an outer wall of the first clear water tank is provided with a clear water inlet and a clear water outlet that are in communication with an interior of the first clear water tank, the inlet valve is in communication with the clear water inlet for controlling the clear water to input through the clear water inlet to replenish the clear water to the first clear water tank, the clear water outlet is in communication with the clear water exchange port for replenishing the clear water to the intelligent cleaning machine through the clear water exchange port; the clear water outlet is connected with a three-way pipe, the three-way pipe is provided with a first pipe port, a second pipe port, and a third pipe port that are in communication with each other, the first pipe port is connected to an air replenish valve, the second pipe port is in communication with the clear water outlet, and the third pipe port is in communication with the clear water exchange port to replenish the clear water to the intelligent cleaning machine through the clear water exchange port.

15. The water exchange base station according to claim 14, wherein the first clear water tank is provided with a quick connector; a first end of the quick connector is the clear water inlet, a second end of the quick connector is provided with an inlet channel, and the clear water inlet is in communication with the inlet channel so that the clear water enters the first clear water tank; the first clear water tank is provided therein with a water volume control device, an end of the water volume control device is movably connected in the inlet channel, and when the clear water in the first clear water tank reaches a preset degree, the water volume control device blocks the inlet channel so that the clear water is prevented from entering the first clear water tank.

16. The water exchange base station according to claim 2, wherein the main body is provided with a charging connector electrically connected with the pump, and the charging connector is configured for obtaining an electric energy from the intelligent cleaning machine.

17. The water exchange base station according to claim 1, wherein the main body is provided therein with a battery configured for supplying power to a communication module, so that the water exchange base station is in communication with the intelligent cleaning machine before or during docking with the intelligent cleaning machine.

18. The water exchange base station according to claim 1, wherein the water exchange base station further comprises:
a water collection groove, arranged at a bottom of the main body and configured for collecting water leaking out of the main body;
a first control module, arranged in the main body; and a water level detection member, at least partially arranged in the water collection groove and electrically connected with the first control module; when a water level in the water collection groove spreads to the water level detection member, the first control module controls the water exchange base station to stop work.

19. The water exchange base station according to claim 18, wherein the main body comprises a housing and a bottom cover; the bottom cover is arranged at a bottom of the housing, and the water collection groove is arranged above the bottom cover; a bottom wall of the housing is provided with at least one diversion port in communication with the water collection groove, and the water leaking from the main body is gathered in the water collection groove through the diversion port.

20. The water exchange base station according to claim 18, wherein the water level detection member comprises a positive probe and a negative probe that are electrically connected to the first control module; the positive probe and the negative probe are symmetrical and spaced apart, and lower ends of the positive probe and the negative probe are at least partially extended into the water collection groove.

21. The water exchange base station according to claim 1, wherein the main body is further provided therein with a second control module and a first detection module, and the second control module is electrically connected with the first detection module;
the first detection module is configured for detecting whether the intelligent cleaning machine is docked with the water exchange base station in place; and the second control module is configured for controlling to supply the clear water to the clear water port of the intelligent cleaning machine through the clear water exchange port of the water exchange base station, and/or to collect the sewage from the sewage port of the intelligent cleaning machine through the sewage exchange port of the water exchange base station; and for controlling to stop supply the clear water and/or collect the sewage according to a preset time or detection information from the intelligent cleaning machine.

22. An intelligent cleaning machine configured for automatically docking with a water exchange base station comprising:
a main body;
a sewage exchange port, arranged on the main body and configured for docking with a sewage port of the intelligent cleaning machine;
a clear water exchange port, arranged on the main body and configured for docking with a clear water port of the intelligent cleaning machine;
a first clear water connecting port, arranged on the main body and configured for connecting with an external water source;
a first sewage connecting port, arranged on the main body and in communication with the sewage exchange port and configured for discharging a sewage to an outside; and an inlet valve, configured for controlling a clear water to enter the water exchange base station or the intelligent cleaning machine;
wherein when the clear water port of the intelligent cleaning machine is docked with the clear water exchange port and is in a state of supplying clear water, the first clear water connecting port is in communication with the clear water exchange port, and the clear water exchange port supplies the clear water to the intelligent cleaning machine; and
wherein when the sewage port of the intelligent cleaning machine is docked with the sewage exchange port and is in a state of discharging sewage, the sewage in the intelligent cleaning machine is drawn out from the sewage exchange port and discharged from the first sewage connecting port to the outside;
wherein the intelligent cleaning machine comprises;
a shell;
a second clear water tank, arranged inside the shell; and
a sewage tank, arranged inside the shell;
wherein the shell is provided with a clear water port in communication with the second clear water tank and a sewage port in communication with the sewage tank; the sewage port is configured for docking with the sewage exchange port of the water exchange base station to discharge sewage to an outside through the water exchange base station, and the clear water port is configured for docking with the clear water exchange port of the water exchange base station to connect an external water source through the water exchange base station and supply clear water to the intelligent cleaning machine.

23. The intelligent cleaning machine according to claim 22, wherein a rechargeable battery is provided in the shell, and the shell is provided with a charging portion electrically connected to the rechargeable battery, and the charging portion is configured for supply power to a pump of the water exchange base station.

24. The intelligent cleaning machine according to claim 22, wherein the shell is further provided therein with a third control module and a second detection module electrically connected with the third control module; the sewage tank is provided therein with a sewage sensor configured for detecting whether the sewage is full, and the second clear water tank is provided therein with a clear water sensor configured for detecting whether the clear water is empty;
the third control module is configured for controlling the intelligent cleaning machine to enter a state of water exchanging and move to the water exchange base station after the sewage sensor detects that the sewage in the sewage tank is full, or after the clear water sensor detects that the clear water in the second clear water tank is empty;
the second detection module is configured for detecting a location of the water exchange base station when the intelligent cleaning machine is in the state of water exchanging, so that the sewage port is docked with the sewage exchange port of the water exchange base station and/or the clear water port is docked with the clear water exchange port of the water exchange base station; and
the third control module is further configured for controlling to start and to stop discharging and/or supplying water based on a preset time, information from the water exchange base station or the detection information from the intelligent cleaning machine after the intelligent cleaning machine is docked with the water exchange base station in place.

25. An intelligent cleaning machine water exchange system, comprising:
a water exchange base station comprising:
a main body;
a sewage exchange port, arranged on the main body and configured for docking with a sewage port of the intelligent cleaning machine;
a clear water exchange port, arranged on the main body and configured for docking with a clear water port of an intelligent cleaning machine;
a first clear water connecting port, arranged on the main body and configured for connecting with an external water source;
a first sewage connecting port, arranged on the main body and in communication with the sewage exchange port and configured for discharging a sewage to an outside; and an inlet valve, configured for controlling a clear water to enter the water exchange base station or the intelligent cleaning machine;
wherein when the clear water port of the intelligent cleaning machine is docked with the clear water exchange port and is in a state of supplying clear water, the first clear water connecting port is in communication with the clear water exchange port, and the clear water exchange port supplies the clear water to the intelligent cleaning machine; and
wherein when the sewage port of the intelligent cleaning machine is docked with the sewage exchange port and is in a state of discharging sewage, the sewage in the intelligent cleaning machine is drawn out from the sewage exchange port and discharged from the first sewage connecting port to the outside;
an intelligent cleaning machine comprising;
a shell;
a second clear water tank, arranged inside the shell; and a sewage tank, arranged inside the shell;
wherein the shell is provided with a clear water port in communication with the second clear water tank and a sewage port in communication with the sewage tank; the sewage port is configured for docking with the sewage exchange port of the water exchange base station to discharge sewage to an outside through the water exchange base station, and the clear water port is configured for docking with the clear water exchange port of the water exchange base station to connect an external water source through the water exchange base station and supply clear water to the intelligent cleaning machine; and
a cleaning base station;
wherein the water exchange base station is configured for supplying water to the intelligent cleaning machine, or for drawing out the sewage in the intelligent cleaning machine when the intelligent cleaning machine is automatically docked with the water exchange base station, and the cleaning base station is configured for supplying a power to the intelligent cleaning machine and for collecting a dust in the intelligent cleaning machine.
